(19) United States
(12) Patent Application Publication
(10) Pub. No.: US 2013/0208601 A1
(43) Pub. Date: Aug. 15, 2013

(54) MEASUREMENT REQUESTING AND REPORTING

(71) Applicants: Tao Cui, Upplands Vasby (SE); Prabaharan Kanesalingam, Ottawa (CA)

(72) Inventors: Tao Cui, Upplands Vasby (SE); Prabaharan Kanesalingam, Ottawa (CA)

(21) Appl. No.: 13/144,160

(22) PCT Filed: May 17, 2011
(86) PCT No.: PCT/SE11/05619

§ 371 Date: Mar. 20, 2013

Related U.S. Application Data
(60) Provisional application No. 61/411,380, filed on Nov. 8, 2010.

(51) Int. Cl. H04W 24/10

(52) U.S. Cl. CPC H04W 24/10
USPC 370/252

(57) ABSTRACT

A method of operating a node of a communications network comprises the node requesting a user equipment unit to prepare a measurement report concerning a measurement object. The measurement report includes (a) a measurement result for the measurement object as measured from a current serving cell and a measurement result for the measurement object as measured from a neighbor cell; and (b) additional measurement reporting including measurements that are available at the user equipment unit from multiple serving carriers. The method further comprises the node configuring the user equipment unit to ensure that the user equipment unit includes a reference signal received power (RSRP) value for the measurement result for the measurement object as measured from the neighbor cell.

### TECHNICAL FIELD

This invention pertains to the ordering (e.g., network configuring) and reporting of measurements in a communications network, and particularly to a communications network which employs carrier aggregation.

### BACKGROUND

In a typical cellular radio system, wireless terminals (also known as mobile stations and/or user equipment units (UEs)) communicate via a radio access network (RAN) to one or more core networks. The radio access network (RAN) covers a geographical area which is divided into cell areas, with each cell area being served by a base station, e.g., a radio base station (RBS), which in some networks may also be called, for example, a “NodeB” (UMTS) or “eNodeB” (LTE) or eNB. A cell is a geographical area where radio coverage is provided by the radio base station equipment at a base station site. Each cell is identified by an identity within the local radio area, which is broadcast in the cell. The base stations communicate over the air interface operating on radio frequencies with the user equipment units (UE) within range of the base stations.

In some versions of the radio access network, several base stations are typically connected (e.g., by landlines or microwave) to a controller node (such as a radio network controller (RNC) or a base station controller (BSC)) which supervises and coordinates various activities of the plural base stations connected thereto. The radio network controllers are typically connected to one or more core networks.

The Universal Mobile Telecommunications System (UMTS) is a third generation mobile communication system, which evolved from the second generation (2G) Global System for Mobile Communications (GSM). UTRAN is essentially a radio access network using wideband code division multiple access for user equipment units (UEs). In a forum known as the Third Generation Partnership Project (3GPP), telecommunications suppliers propose and agree upon standards for third generation networks and UTRAN specifically, and investigate enhanced data rate and radio capacity. Specifications for the Evolved Universal Terrestrial Radio Access Network (E-UTRAN) are ongoing within the 3^{rd} Generation Partnership Project (3GPP). The Evolved Universal Terrestrial Radio Access Network (E-UTRAN) comprises the Long Term Evolution (LTE) and System Architecture Evolution (SAE). Long Term Evolution (LTE) is a variant of a 3GPP radio access technology wherein the radio base station nodes are connected to a core network (via Serving Gateways, or SGWs) rather than to radio network controller (RNC) nodes. In general, in LTE the functions of a radio network controller (RNC) node are distributed between the radio base stations nodes (eNodeBs in LTE) and SGWs. As such, the radio access network (RAN) of an LTE system has an essentially “flat” architecture comprising radio base station nodes without reporting to radio network controller (RNC) nodes.

3GPP TS 36.331 is one 3GPP standard referenced herein, and when so referenced can include, e.g., 3GPP TS 36.331, v. 9.4.0, 3rd Generation Partnership Project; Technical Specification Group Radio Access Network; Evolved Universal Terrestrial Radio Access (E-UTRA); Radio Resource Control (RRC); Protocol Specification, Release 9, 2010-09.

The 3GPP LTE Release-8 (“Rel-8”) standard has recently been finalized, supporting bandwidths up to 20 MHz. However, in order to meet the upcoming IMT-Advanced requirements, 3GPP has initiated work on LTE-Advanced. One of the parts of LTE-Advanced is to support bandwidths larger than 20 MHz. This will be achieved using a concept called “Carrier Aggregation”, where multiple carrier components, each of which may be up to 20 MHz wide, are aggregated together. Carrier aggregation is planned for Release 10 (Rel-10) of the 3GPP LTE specifications.

Carrier aggregation implies that an LTE Rel-10 terminal can receive multiple component carriers, where the component carriers have, or at least the possibility to have, the same structure as a Rel-8 carrier. Carrier aggregation is illustrated in FIG. 1.

In carrier aggregation, the user equipment unit (UE) sets up the RRC connection first. The cell where the RRC connection request is successful becomes the primary cell of the user equipment unit (UE). The carrier frequency where the primary cell belongs is called primary component carrier (PCC). Then, based on UE capability, the network may configure one or more secondary cells (SCC) on other component carriers which are then called secondary component carrier. The secondary cells are different from primary cells, and are on different carrier frequencies.

Carriers can be aggregated contiguously, like in FIG. 1, or they may be aggregated from discontinuous portions in the frequency domain, such that, e.g., parts of the aggregated carriers may be contiguous, and other aggregated carriers appear somewhere else in the spectrum, as schematically illustrated in FIG. 2.

With the carrier aggregation concept, it may be possible to support, among other things, higher bit-rates; framing of non-contiguous spectrum, i.e., to provide high bit-rates and better capacity also in cases when an operator lacks contiguous spectrum; and, fast and efficient load balancing between carriers.

Carrier aggregation is a UE-centric concept, in that one user equipment unit (UE) may be configured to use, e.g., the two left-most carriers in FIG. 2 above, another user equipment unit (UE) may be configured to use only a single carrier, and a third UE may be configured to use all of the carriers depicted in FIG. 2.

Thus, an eNB (LTE radio base station) may be in control of all four carriers in FIG. 2, but Rel-10 UEs may have different Configured Component Carriers (Configured CCs) that each Rel-10 UE is configured to use. Recently, it has been defined that a UE will have one Primary Cell (PCell) configured, and possibly one or several additional Serving Cells (SCells). The PCell is carried on the Primary Component Carrier (PCC), while the SCells are carried on Secondary Component Carriers (SCCs). The same carriers may also be available for Rel-8 UEs, meaning that each of the carriers may be independently available for single cell operation.

A particular and relevant example of a plausible carrier aggregation scenario includes the case when two or more Rel-8 compatible downlink carriers are aggregated for a UE. It should be noted that carrier aggregation is typically and mainly relevant for a Connected UE, which is a UE that is actively involved in transmission to and from the eNB (E-UTRAN base station), and thus has a connection with the eNB controlling the aggregated carriers.

Measurement configurations are controlled by the eNB, e.g., the eNB tells the UE, e.g., when to perform measurements, what to measure, how to filter the measurements, how to evaluate when to report the measurements and what to include in the report.

The Rel-8/9 of the LTE specifications (e.g., 3GPP TS 36.331, v. 9.4.0) support a versatile measurement model where different events with thresholds can be configured, such that the UE sends measurement reports to the network when, e.g., the relative signal strength between the current “Serving Cell” and a “Neighbor Cell” is changing, such that a handover may be necessary. This could occur, e.g., when the UE moves from one cell to another, as depicted in FIG. 3.

In Rel-8, the “Serving Cell” denotes the cell that the UE is connected to, while the “Neighbor Cell” may be another cell in close proximity on the same frequency (intra-frequency measurements), or on a different frequency (inter-frequency measurements). The neighbor may also be realized using a different Radio Access Technology (inter-RAT measurements).

The “Neighbor Cell” may be on the same carrier as the “Serving Cell” or, it may be on a different carrier. The comparison resulting in a potential measurement report is dependent on the configuration provided by the eNB.

Rel-8 includes different event-triggers for issuing reports from the UE to the eNB, when certain conditions are fulfilled. For example, Rel-8 includes the trigger A3 defined as follows:

Event A3: Neighbour becomes amount of offset better than serving.

Additional triggers and definitions can be found in TS 36.331.

Below are selected definitions used in TS 36.331 (e.g., 3GPP TS 36.331, v. 9.4.0). Additional definitions can be found, e.g., in chapter 5.5 of TS 36.331.
Measurement objects: The objects on which the UE shall perform the measurements. For intra-frequency and inter-frequency measurements a measurement object is a single E-UTRA carrier frequency (associated with this carrier frequency, E-UTRAN can configure a list of cell specific offsets and a list of ‘blacklisted’ cells. Blacklisted cells are not considered in event evaluation or measurement reporting). For inter-RAT UTRA measurements a measurement object is a set of cells on a single UTRA carrier frequency. For inter-RAT GERAN measurements a measurement object is a set of GERAN carrier frequencies. For inter-RAT CDMA2000 measurements a measurement object is a set of cells on a single (HRPD or 1xRTT) carrier frequency.
Reporting configurations: A list of reporting configurations where each reporting configuration comprises Reporting Criterion and Reporting Format. The Reporting Criterion is the criterion that triggers the UE to send a measurement report (which can either be periodical or a single event description). The Reporting Format specifies the quantities that the UE includes in the measurement report and associated information (e.g., number of cells to report).
Measurement identities: A list of measurement identities where each measurement identity links one measurement object with one reporting configuration. By configuring multiple measurement identities it is possible to link more than one measurement object to the same reporting configuration, as well as to link more than one reporting configuration to the same measurement object. The measurement identity is used as a reference number in the measurement report.

Regardless of which event triggered a UE to send measurement report, the same serving cell gets included in all the measurement reports.

As described above, in Rel-8/9 of LTE, a measurement report may be triggered, e.g., by an event such as Event A3. Once triggered, in Rel-8/9 of LTE a measurement result of the Serving Cell and best neighbor cell are always included in the measurement report. The information element (IE) MeasResults covers measured results for intra-frequency, inter-frequency, and inter-RAT mobility.

The Rel-8/9 measurement model allows the network to configure either referenced signal received power (RSRP) or referenced signal received quality (RSRQ) as the “triggerQuantity” per event to be used for best cell evaluation as well as ordering the selected best neighbour cells (measResultNeighCell). For example, the information element triggerQuantity may be declared as follows:

triggerQuantity ENUMERATED {rsrp, rsrq},

The flexibility (in allowing the network to configure either referenced signal received power (RSRP) or referenced signal received quality (RSRQ) as the “triggerQuantity” per event) is needed since some events are used for evaluating best cells on the same carrier for which referenced signal received power (RSRP) is more appropriate while some other events are used for evaluating cells on different carriers for which referenced signal received quality (RSRQ) is more appropriate.

The Rel 8/9 measurement model also allows the network to configure a “reportQuantity” which gives the network the flexibility to request a measurement result to include quantity(ies) indicated by “reportQuantity” in measResultNeighCell. For example, the information element reportQuantity may be declared as follows:

reportQuantity ENUMERATED {sameAsTriggerQuantity, both},

This flexibility for configuring “reportQuantity” is needed since the network decision (e.g., whether the network needs measurements for handover purposes) usually gets triggered at the cell edge and thus the network could control the message of the measurement reports. This flexibility is needed also depending on which measurement event has triggered the measurement reporting, e.g., for the handover purpose the network may want to receive both quantities in order to make an appropriate handover decision.

In the 3GPP RAN Working Group 2, it was agreed that a UE that supports Carrier Aggregation is to be capable of providing “additional measurements” of other cells not directly related to the cells involved in triggering the measurement report, if the UE has such additional measurements available. These measurements are “additional” in this sense: measurements of the object(s) related to the triggering of the report have already been included in the existing fields in Rel-8/9 measurement results. The purpose of the additional measurement reporting is to, e.g., make the eNB select the most suitable PCell and SCells at handover taking into account also the eNB load situation and the potential inter-cell interferences. The additional measurement reporting could be also useful in the SCell management. The network indicates whether the UE should provide such additional measurements in the reportConfig.

The intention of the additional reporting is to let the user equipment unit (UE) include measurement results on frequencies that are not associated with the measurement object that has triggered the measurement report from the user equipment unit (UE). However, the additional reporting does not require the user equipment unit (UE) to perform additional measurements, but rather to report the measurement results which are already available in the UE. Those measurement results may be available because the UE has been configured by the network to measure on certain frequencies. So these measurement results may have reached the threshold set by the network to report but may not fulfill the time-two-trigger (TTT). The regular reporting is only triggered when it fulfills the configured TTT but that is not the case for including additional measurements.

These 3GPP RAN Working Group 2 developments/agreements mean that a UE should be capable of providing “additional information” of the observed radio environment, including information of cells that have not been directly involved in the triggering of the measurement report once requested by the network (e.g., the cells on frequencies that are not associated with the measurement object that has triggered the measurement report). The understanding in RAN2 is that a UE should provide such measurements if the UE has any measurements available, i.e., it is probable that this reporting should not impose any new measurement requirements on the UE.

FIG. 4 shows an example network scenario, and particularly illustrates example cells from which a user equipment unit (UE) may receive signals, including signals from serving cells and neighbor cells. FIG. 4 shows a serving cell (PCell) and a neighbor cell for a primary component carrier (PCC) frequency x; a serving cell (SCellₙ) and a neighbor cell for a secondary component carrier (SCCₙ) frequency y; and a neighbor cell for carrier frequency z. It should be understood by the “n” subscription notation that there can be more than one secondary component carrier, and for each secondary component carrier there is a serving cell and most likely a neighbor cell. In FIG. 4, the line A3 depicts the measurement event that typically triggers a handover (HO). The measurement results provided by the UE will help the network node (e.g., eNodeB) decide which cell should become the Primacy cell (PCell) when handover occurs. During handover preparation, the source eNodeB will also forward to the target eNodeB a list of potential cells which could become the secondary serving cells for the UE. This list is based on the measurement results from the user equipment unit (UE). Thus, it is advantageous to receive the measurement results not only on the frequency corresponding to the measObject but also on all serving frequencies, for which reason the additional measurements reporting is provided.

A problem with the measurement configuration and the subsequent event reporting arises when Carrier Aggregation is introduced. As noted above, the 3GPP RAN2 working group has recently agreed that all the measurements reported by carrier aggregation-capable UEs shall include additional measurements once configured by the network for additional reporting. As illustrated above, in Rel-8/9, the UE always reports best neighbor cells of the frequency with the associated measurement object which is linked to the measurement ID that has triggered the measurement report. The best cell evaluation is performed by the network configured parameter triggerQuantity (RSRP or RSRQ) and the measurement result will only include quantity (ies) indicated by “reportQuantity”.

In Rel 10, when a network requests the UE to provide additional measurement results, it is not clear from the current specification whether the UE needs to include additional measurement results for the frequency indicated in the associated measObject. A natural extension is to include additional measurements for all the serving frequencies, but in doing this some aspects of the measurement results are unnecessarily sent twice within the same measurement report. The size of the measurement report is thus unnecessarily increased.

Since measResultNeighCell does always contain best neighbor cells of the frequency with the associate measObject, as described further herein the inventors have determined that it is better to exclude the same measurement results in the additional measurement reporting.

But question arises whether it is sufficient to accept the measurement result in measResultNeighCell as the additional measurement reporting regardless of the triggerQuantity & reportQuantity configuration. For example, assume that a UE is configured with three Component Carriers (CCs), as illustrated by way of example in FIG. 5. That is, the UE is configured with three downlink (DL) component carriers (one PCell, two SCells, and thus in the Rel-8 model has three serving cells). The network has two different ways of configuring its triggerQuanity and reportQuantity parameters for the reporting purposes, i.e., Configuration 1 and Configuration 2:

In Configuration 1 the network sets the parameters as follows:
triggerQuantity=RSRP
reportQuantity=both
   In Configuration 1 the UE will perform best cell evaluation on Object2 using RSRP and will report best neighbors on Object2 with both RSRP & RSRQ quantities in the measurement result in measResultNeighCell.

In Configuration 2 the network sets the parameters as follows:
triggerQuantity=RSRQ
reportQuantity=sameasTriggerQuantity
   In Configuration 2 the UE will perform best cell evaluation on Object2 using RSRQ and will report best neighbors on Object2 with only RSRQ quantity in the measurement result in measResultNeighCell.

For Configuration 1, the measurement result in measResultNeighCell is sufficient to be used as an additional measurement report since it contains both referenced signal received power (RSRP) & referenced signal received quality (RSRQ) results.

However, for Configuration 2, however, the measurement result in measResultNeighCell is not sufficient to be used as an additional measurement report since it contains only the referenced signal received quality (RSRQ) result. The critical referenced signal received power (RSRP) quantity is missing in measResultNeighCell, which is very essential to make the SCell selection at the target eNB during handover.

As indicated before, one possible solution is to define a requirement on the UE to always include additional measurements from all the serving frequencies. However, doing so would unnecessarily duplicate the measurement results corresponding to the associated measurement object in the measurement report and thereby increase the measurement report message size. This is clearly not desired, as the size of the measurement report could be critical when the UE is in a bad radio condition. It may cause radio link failure (RLF) and further the UE may lose the RRC connection since the measurement report use Radio Link Control (RLC) acknowledge mode (AM).

### SUMMARY

In one of its aspects the technology disclosed herein concerns a method of operating a node of a communications network. The method comprises the node configuring a user equipment unit to prepare a measurement report concerning a measurement object. The measurement report includes (a) a measurement result for the measurement object as measured from a current serving cell and a measurement result for the measurement object as measured from a neighbor cell; and (b) additional measurement reporting including measurements that are available at the user equipment unit from multiple serving carriers. The method further comprises the node configuring the user equipment unit to ensure that the user equipment unit includes a reference signal received power (RSRP) value for the measurement result for the measurement object as measured from the neighbor cell.

In an example embodiment and mode the method of operating the node further comprises the node configuring the user equipment unit to ensure that the user equipment unit include both the reference signal received power (RSRP) value and a reference signal received quality (RSRQ) value for the measurement result for the measurement object as measured from the neighbor cell. In an example implementation, the method further comprises the node requesting that the user equipment unit set a parameter reportQuantity to require the user equipment unit to include both the reference signal received power (RSRP) value and the reference signal received quality (RSRQ) value for the measurement result for the measurement object as measured from the neighbor cell.

In an example embodiment and mode the method of operating the node further comprises the node requesting that the user equipment unit exclude the measurement result for the measurement object as measured from the neighbor cell from the additional measurement reporting of the measurement report. In an example implementation, the method comprises the node configuring the user equipment unit (1) to format the measurement report to comprise a measurement result report section for the measurement object and an additional reporting section; and (2) to exclude the measurement result for the measurement object as measured from the neighbor cell from the additional measurement reporting section of the measurement report so that the measurement result for the measurement object as measured from the neighbor cell appears only once in the measurement report.

In an example embodiment and mode the method of operating the node further comprises the node requesting that the user equipment unit (UE) ensure that the user equipment unit includes a reference signal received power (RSRP) value for the measurements of the additional measurement reporting. For example, in an example implementation the method further comprises the node requesting that the user equipment unit (UE) ensure that the user equipment unit includes a reference signal received power (RSRP) value for an available measurement of a serving carrier from a non-serving cell. In an example implementation, the method further comprises performing a best cell evaluation for a carrier using one or more signal received power (RSRP) values included in the measurement report.

In an example embodiment and mode, the method of operating the node further comprises performing a best cell evaluation for a carrier using the signal received power (RSRP) value.

In another of its aspect the technology disclosed herein concerns a node of a communications network which communicates with a user equipment unit over an air interface. The node is arranged to configure the user equipment unit to send a measurement report to the network concerning a measurement object for which the measurement report is to be triggered. As indicated above, the measurement report includes a) a measurement result for the measurement object as measured from a current serving cell and a measurement result for the measurement object as measured from a neighbor cell; and (b) additional measurement reporting including measurements that are available at the user equipment unit from multiple serving carriers. The node is further arranged to configure the user equipment unit to include a reference signal received power (RSRP) value for the measurement object as measured from a neighbor cell.

In an example embodiment, the node comprise a communications interface and a configuration unit. The communications interface is configured to provide radio communications with a user equipment unit over an air interface. The configuration unit is arranged to configure the user equipment unit to send the measurement report to the network concerning a measurement object. The measurement report includes (a) a measurement result for the measurement object as measured from a current serving cell and a measurement result for the measurement object as measured from a neighbor cell; and (b) additional measurement reporting including measurements that are available at the user equipment unit from multiple serving carriers. The configuration unit is further arranged to configure the user equipment unit to include a reference signal received power (RSRP) value for the measurement result for the measurement object as measured from the neighbor cell.

In an example embodiment, the configuration unit of the node is further arranged to configure the user equipment unit to ensure that the user equipment unit include both the reference signal received power (RSRP) value and a reference signal received quality (RSRQ) value for the measurement result for the measurement object as measured from the neighbor cell. In an example implementation, the configuration unit of the node is further arranged to configure the user equipment unit by setting a parameter reportQuantity to require the user equipment unit to include both the reference signal received power (RSRP) value and the reference signal received quality (RSRQ) value for the measurement result for the measurement object as measured from the neighbor cell.

In an example embodiment the configuration unit of the node is further arranged to configure the user equipment unit to exclude the measurement result for the measurement object as measured from the neighbor cell from the additional measurement reporting of the measurement report. In an example implementation, the configuration unit is further arranged to configure the user equipment unit: (1) to format the measurement report to comprise a measurement result report section for the measurement object and an additional reporting section; and (2) to exclude the measurement result for the measurement object as measured from the neighbor cell from the additional measurement reporting section of the measurement report so that the measurement result for the measurement object as measured from the neighbor cell appears only once in the measurement report.

In an example embodiment the configuration unit of the node is further arranged to configure the user equipment unit (UE) to ensure that the user equipment unit includes a reference signal received power (RSRP) value for the measurements of the additional measurement reporting. For example, in an example implementation configuration unit may be further arranged to configure the user equipment unit (UE) to ensure that the user equipment unit includes a reference signal received power (RSRP) value for an available measurement of a serving carrier from a non-serving cell.

In an example embodiment the node further comprises an evaluation unit arranged to perform a best cell evaluation for a carrier using one or more signal received power (RSRP) values included in the measurement report.

In an example embodiment the configuration unit and the evaluation unit are realized or comprised by electronic circuitry.

In another of its aspects the technology disclosed herein concerns a method of operating a user equipment unit which communicates with a communications network node. The method comprises the user equipment unit sending a measurement report to the network concerning a measurement object for which the measurement report was triggered. The measurement report includes (a) a measurement result for the measurement object as measured from a current serving cell and a measurement result for the measurement object as measured from a neighbor cell; and (b) additional measurement reporting including measurements that are available at the user equipment unit from multiple serving carriers. The method further comprises the user equipment unit, when performing the additional measurement reporting, including in the measurement report, the reference signal received power (RSRP) value for the measurement object as measured from the neighbor cell.

In an example embodiment and mode the method of operating the user equipment unit further comprises the user equipment unit, when performing the additional measurement reporting, including in the measurement report, as the measurement result for the measurement object as measured from the neighbor cell, both the reference signal received power (RSRP) value and the reference signal received quality (RSRQ) value.

In an example embodiment and mode, the method of operating the user equipment unit further comprises the user equipment unit excluding the measurement result for the measurement object as measured from the neighbor cell from the additional measurement reporting of the measurement report. In an example implementation, the method further comprises the user equipment unit formatting the measurement report to comprise both a measurement result report section for the measurement object and an additional reporting section; and the user equipment unit excluding the measurement result for the measurement object as measured from the neighbor cell from the additional measurement reporting section of the measurement report so that the measurement result for the measurement object as measured from the neighbor cell appears only once in the measurement report.

In an example embodiment and mode the measurement object is linked by a measurement identity to a measurement trigger, and the method of operating the user equipment unit further comprises: (1) including in the measurement identity a list of serving frequencies which are linked to the measurement trigger; and, (2) other than a serving frequency corresponding to the measurement object, for each of the serving frequencies on the list including in the additional measurement reporting a measurement from a non-serving cell. In an example implementation, the measurement for each of the serving frequencies from a non-serving cell is from a best non-serving cell, and the measurement for each of the serving frequencies is a reference signal received power (RSRP) value.

In another of its aspects the technology disclosed herein concerns a user equipment unit which sends a measurement report over an air interface to a communications network node. The user equipment unit is arranged to prepare a measurement report to send to the network concerning a measurement object for which the measurement report was triggered. The measurement report including (a) a measurement result for the measurement object as measured from a current serving cell and a measurement result for the measurement object as measured from a neighbor cell; and (b) additional measurement reporting including measurements that are available at the user equipment unit from multiple serving carriers. The user equipment unit also is arranged, when performing the additional measurement reporting, to include in the measurement report, the reference signal received power (RSRP) value for the measurement object as measured from a neighbor cell.

In an example embodiment the user equipment unit comprises a measurement report unit and a communications interface. The measurement report unit is configured to prepare a measurement report to send to the network concerning a measurement object for which the measurement report was triggered. The measurement report includes (a) a measurement result for the measurement object as measured from a current serving cell and a measurement result for the measurement object as measured from a neighbor cell; and (b) additional measurement reporting including measurements that are available at the user equipment unit from multiple serving carriers. The measurement report unit is further configured, to include, in the measurement report, the reference signal received power (RSRP) value for the measurement result for the measurement object. The communications interface is configured to send the measurement report over an air interface to a communications network node.

In an example embodiment the measurement report unit of the user equipment unit is further configured, when performing the additional measurement reporting, to include in the measurement report, as the measurement result for the measurement object as measured from the neighbor cell, both the reference signal received power (RSRP) value and the reference signal received quality (RSRQ) value.

In an example embodiment the measurement report unit of the user equipment unit is further configured to exclude the measurement result for the measurement object as measured from the neighbor cell from the additional measurement reporting of the measurement report. In an example implementation, the measurement report unit is further configured: (1) to format the measurement report to comprise both a measurement result report section for the measurement object and an additional reporting section; and (2) to exclude the measurement result for the measurement object as measured from the neighbor cell from the additional measurement reporting section of the measurement report so that the measurement result for the measurement object as measured from the neighbor cell appears only once in the measurement report.

In an example embodiment the measurement object is linked by a measurement identity to a measurement trigger, and the measurement report unit is further configured to: (1) include in the measurement identity a list of serving frequencies which are linked to the measurement trigger; and, (2) other than a serving frequency corresponding to the measurement object, for each of the serving frequencies on the list to include in the additional measurement reporting a measurement from a non-serving cell.

In an example implementation, the measurement for each of the serving frequencies from a non-serving cell is from a best non-serving cell, and the measurement for each of the serving frequencies is a reference signal received power (RSRP) value.

In an example embodiment, the configuration unit is comprised or realized by electronic circuitry.

In at least one of its aspects, the technology disclosed herein allows the user equipment unit (UE), e.g., wireless terminal, include both referenced signal received power (RSRP) & referenced signal received quality (RSRQ) quantities in the measurement results all the times, thereby the required RSRP result are available in the measResultNeighCell all the times regardless of the trigger quantity thereby to eliminate associated measObject from additional measurement reporting.

According to one aspect of the technology disclosed herein, there is provided a method for additional measurement handling in wireless terminals configured to receive best non-serving cell information from multiple serving carriers as additional measurements, where the associated measurement object is characterized by an object which is linked to the measurement ID that triggered the measurement report. If the network configures the additional measurement reporting when a measurement event is triggered, it needs also to ensure that the reportQuantity is set to “both” so that the measurement result will include both RSRP and RSRQ quantities in the existing measResultNeighCell in the measurement report.

Since both referenced signal received power (RSRP) and referenced signal received quality (RSRQ) quantities are included in the measurement result corresponding to the associated measObj in measResultNeighCell, the associated measObj may be excluded from the additional measurement reporting.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic view showing carrier aggregation in an example wherein five bands of twenty MHz each are aggregated together.

FIG. 2 is a diagrammatic view showing an example of contiguous and non-contiguous carriers with different bandwidths.

FIG. 3 is a graph illustrating signal strength between a current “Serving Cell” and a “Neighbor Cell”.

FIG. 4 shows an example network scenario, and particularly illustrates example cells from which a user equipment unit may receive signals, including signals from serving cells and neighbor cells.

FIG. 5 is a diagrammatic view showing a situation when a UE is configured with three downlink (DL) component carriers (one PCell, two SCells), and wherein in terms of the Rel-8 model, the UE now has three serving cells.

FIG. 6 is a schematic view of a communications system according to an example embodiment.

FIG. 7 is a schematic view of a communications system according to another example embodiment.

FIG. 8 is a more detailed schematic view of an example implementation of a communications system such as both or either that of FIG. 6 or FIG. 7, showing, e.g., an example optional platform or machine implementation.

FIG. 9 is another more detailed schematic view of an example implementation of a communications system such as both or either that of FIG. 6 or FIG. 7, also showing, e.g., an example optional platform or machine implementation.

FIG. 10 is a flowchart illustrates basic, representative, non-limiting acts or steps of a method of operating a communications network according to an example embodiment and mode.

FIG. 11A, FIG. 11B and FIG. 11C are diagrammatic views showing example modes for formatting a measurement report to include a measurement result section and an additional measurement reporting section.

FIG. 12 is a flowchart illustrating basic, representative, non-limiting acts or steps of a method of operating a communications network according to another example embodiment and mode.

FIG. 13 is a flowchart illustrating in more detail basic, representative, non-limiting acts or steps of a method of operating a communications network according to another example embodiment and mode

FIG. 14 is a flowchart illustrating in more detail basic, representative, non-limiting acts or steps of a method of operating a user equipment unit (UE) according to an example embodiment and mode.

FIG. 15 is a schematic view of a network node according to an example embodiment which includes an evaluation unit.

FIG. 16 is a flowchart illustrating basic acts or steps in a method which includes an act of performing a best cell evaluation.

FIG. 17 is a diagrammatic view illustrating an example deployment scenario with three carriers.

FIG. 18 is a diagrammatic view illustrating linkage between information elements for two case studies which illustrate example methods of the technology disclosed herein.

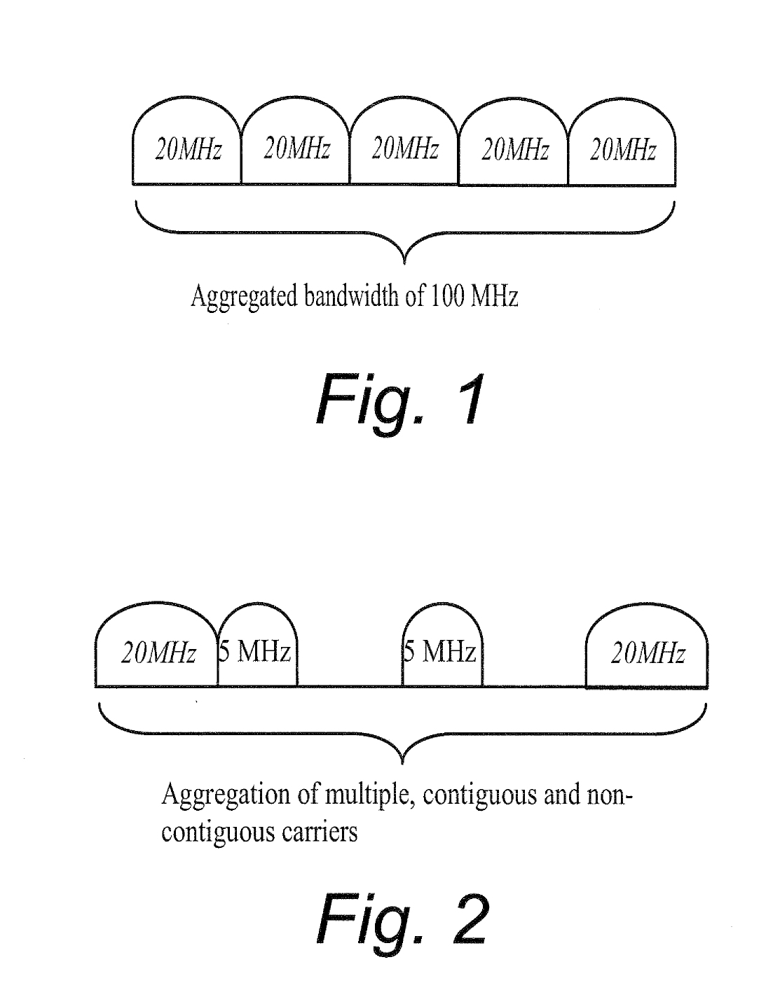

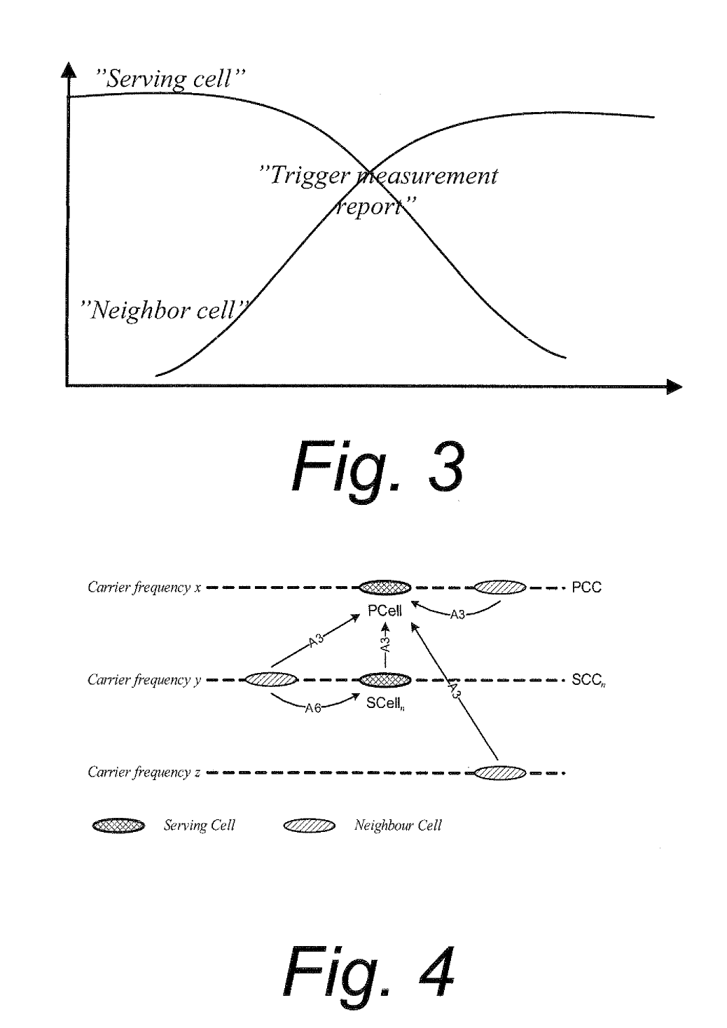

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein may represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

As understood from the preceding, the fact of providing an additional reporting of best non-serving cell(s) has already been agreed in RAN2. The technology disclosed herein addresses topics including but not limited to the following:
The measurement quantity for selecting the best-non serving cell for the additional reporting.
Whether to include (in the additional measurement reporting information) the non-best cells of the of associated measurement object linked to the measurement ID that triggered the measurement report.

The measurement object (measObject) is configured for one carrier frequency. In the measurement results, the user equipment unit (UE) includes the serving cell measurement results and best cells on the frequency with the associated measObject. The frequency for the measObject could be the serving frequency or a different frequency.

The measurement model described in releases 8/9 of 3GPP TS 36.331, v. 9.4.0 allows the network to configure per event either referenced signal received power (RSRP) or referenced signal received quality (RSRQ) as the “triggerQuantity” per events to be used for best cell evaluation as well as ordering the selected best neighbour cells (measResultNeighCell). As mentioned above, this flexibility is needed since some events are used for evaluating best cells on the same carrier (for which RSRP is more appropriate) while some other events are used for evaluating cells on different carriers (for which RSRQ is more appropriate).

Thus, some implementations may involve additional reporting of the best non-serving cell. The following are three possible options available for best cell evaluation for additional reporting purposes:
Option 1: re-use the triggerQuantity corresponding to the reporting configuration which triggered the measurement report.
Option 2: By default use referenced signal received power (RSRP).
Option 3: By default use referenced signal received quality (RSRQ).

The additional measurement report does comprise one available best non-serving cell from each serving carrier, therefore the best cell evaluation needs to be performed on cells within each serving carrier. Since the measurement quality referenced signal received power (RSRP) is more appropriate for best cell evaluation within the same carrier, in one of its aspects the technology disclosed herein uses option 2 [referenced signal received power (RSRP)] as a way forward for best non-serving cell evaluation for additional reporting. Thus, in one of its aspects the technology disclosed herein uses referenced signal received power (RSRP) for the “best cell” evaluation within a carrier for additional reporting.

The measurement model of 3GPP TS 36.331, v. 9.4.0, releases 8/9, also allows the network to configure a “reportQuantity” which gives the network the flexibility to request a measurement result to include quantity(ies) indicated by “reportQuantity” in measResultNeighCell. As another aspect of the technology disclosed herein, the network may specify the “reportQuantity” to be “both”, e.g., to be both referenced signal received power (RSRP) and referenced signal received quality (RSRQ). For example, the information element may be declared in a manner essentially similar to the following:

reportQuantity ENUMERATED {semeAsTriggerQuantity, both},

When the network sets the parameter/information element reportQuantity to “both”, the measurement result of measResultNeighCell will include both RSRP and RSRQ quantities corresponding to the best cells on the associated measurement object (associated measObject), regardless of the configured triggerQuantity. If the wireless terminal (e.g., UE) needs to report additional measurement for the associated measObject, it is going to be the same as the one reported in measResultNeighCell.

In accordance with this aspect of the technology disclosed herein, the additional reporting may include both the measurement quantities (e.g., both referenced signal received power (RSRP) and referenced signal received quality (RSRQ)) also for the frequency with the associated object. The solution of this aspect of the technology disclosed herein is that the network may configure reportQuantity to ‘both’ when the network configures the additional reporting in reportConfig. Then it is guaranteed that both quantities will be available.

One observation at this juncture is that a network could set an appropriate “reportQuality” to request a measurement result to include necessary measurement quantity(ies) in measResultNeighCell. As per the above observation, there may not be a real need to report the measurement result of the associated measObject again (e.g., twice) in the same measurement report. Therefore, as another aspect of the technology disclosed herein, the associated measObject may be excluded from the additional reporting. Thus, as another aspect of the technology disclosed herein, a wireless terminal (e.g., UE) configured for additional measurement report excludes additional reporting on the associated measurement object (measObject).

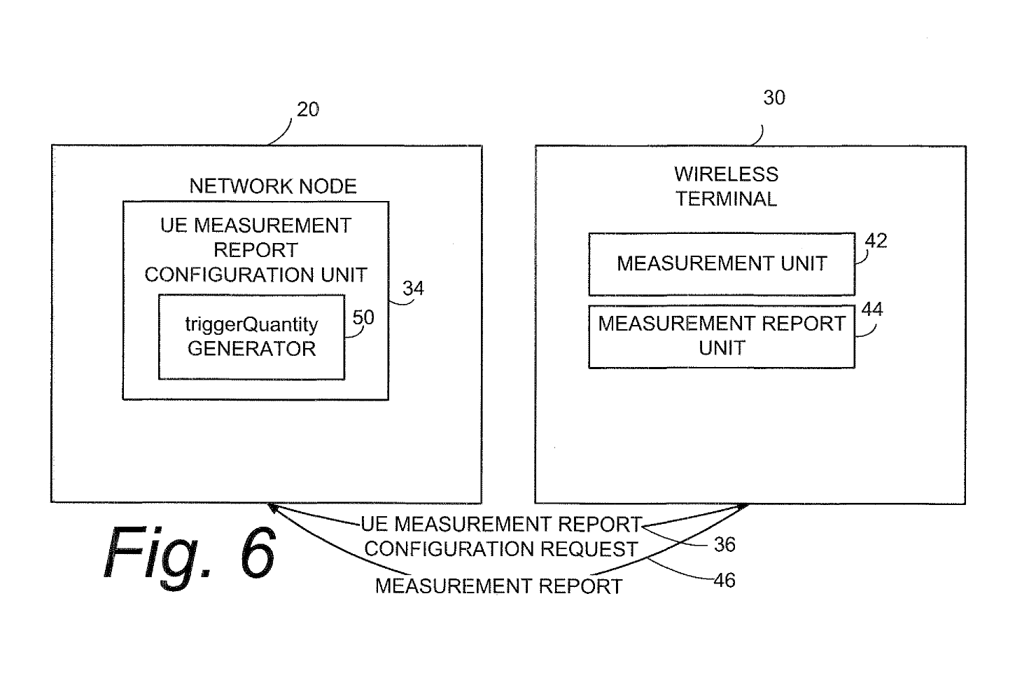

FIG. 6 illustrates an example communications system which includes a network node 20 and a user equipment unit (UE), also known as wireless terminal 30. As shown in FIG. 6, the network node 20 comprises a UE measurement report configuration unit or generator 34, also referred to herein as UE configuration unit 34 or configuration unit 34. The configuration unit 34 is arranged to generate a UE measurement report configuration request 36 (e.g., a message or command, also known as a configuration command) which is sent from network node 20 to the wireless terminal 30. The user equipment unit (UE) 30 comprises measurement unit 42 (which actually performs the measurement(s) which, in some example embodiments, is/are requested by the request 36) and measurement report unit 44 (which prepares/generates the measurement report message 46 or “measurement report” which is returned to the network node 20).

The UE measurement report configuration request 36 may also be viewed as a measurement request. In some example embodiments the request 36 also includes other configuration information such as the trigger configuration(s) which essentially specify when a measurement is to be performed.

In one aspect of the technology disclosed herein and illustrated particularly in FIG. 6, measurement report unit 34 includes in UE measurement report configuration request message 36 (or other appropriate message) a triggerQuantity which specifies or otherwise requires or ensures that the referenced signal received power (RSRP) will be reported, as discussed above. To this end, FIG. 6 shows UE measurement report configuration unit 34 as comprising trigger Quantity generator 50.

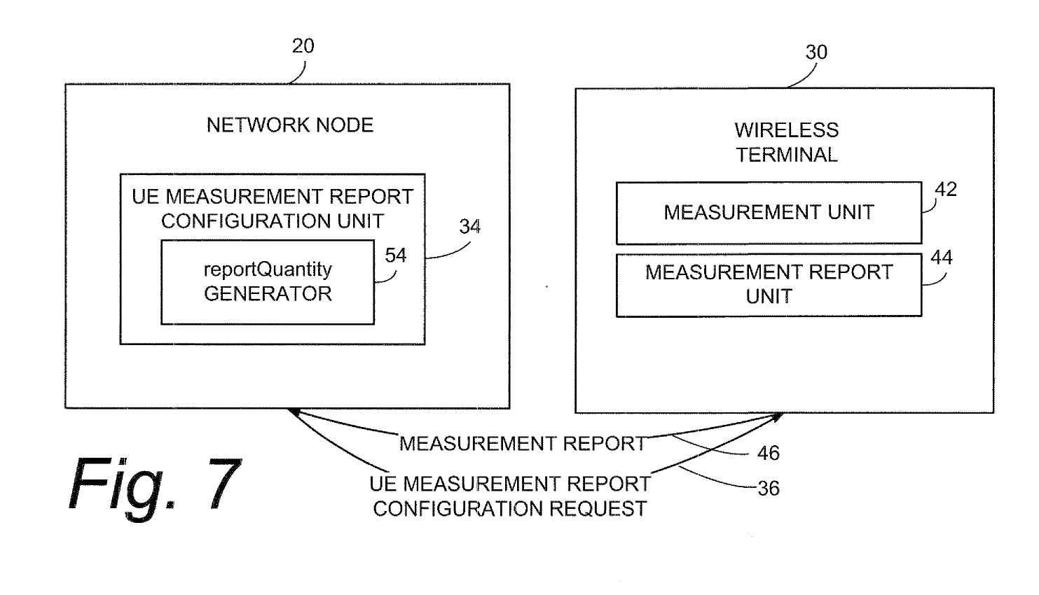

In another aspect of the technology disclosed herein, and illustrated particularly in FIG. 7, the UE measurement report configuration unit 34 comprises reportQuantity generator 54 which is capable of specifying that both referenced signal received power (RSRP) and referenced signal received quality (RSRQ) are to be specified as the reporting quantities in the UE measurement report configuration request 36 or other appropriate message. As a result of such specification, some or all quantities in the measurement report 36 and particularly the measurement result for the measurement object as measured by the user equipment unit from a neighbor cell are provided with both referenced signal received power (RSRP) and referenced signal received quality (RSRQ). As used herein, measurement object as measured by the user equipment unit from a neighbor cell may also be referred to herein as the “associated measurement object”.

In the example FIG. 7 embodiment, configuration unit 34 is arranged to request or configure the user equipment unit 30 to send a measurement report to the network concerning a measurement object for which the measurement report 46 is to be triggered. The requesting/configuring is accomplished, e.g., by the configuration unit 34 generating the UE measurement report configuration request 36 and setting certain parameters or information elements in the UE measurement report configuration request 36 so as to require the user equipment unit (UE) 36 to perform certain actions. The required actions include the UE 30 preparing the measurement report 46 in a manner consistent with the UE measurement report configuration request 36. In particular, the UE measurement report configuration request 36 requires that the measurement report 46 include (a) a measurement result for the measurement object as measured from a current serving cell and a measurement result for the measurement object as measured by the user equipment unit from a neighbor cell; and (b) additional measurement reporting including measurements that are available at the user equipment unit from multiple serving carriers. The configuration unit 34 is further arranged to request/configure the user equipment unit 30 to include, as the measurement result for the measurement object as measured by the user equipment unit from a neighbor cell, both a reference signal received power (RSRP) value and a reference signal received quality (RSRQ) value. The configuration unit 34 may also be further arranged to request that the user equipment unit 30 exclude the measurement result for the measurement object as measured by the user equipment unit from a neighbor cell from the additional measurement reporting of the measurement report.

In the wireless terminal 30 of FIG. 7, measurement report unit 44 is configured (in response to the UE measurement report configuration request 36) to prepare measurement report 46 to send to the network concerning a measurement object for which the measurement report was triggered. As understood from the foregoing, the measurement report 46 includes (a) a measurement result for the measurement object as measured from a current serving cell and a measurement result for the measurement object as measured by the user equipment unit from a neighbor cell; (b) additional measurement reporting including measurements that are available at the user equipment unit from multiple serving carriers. The measurement report unit 44 of wireless terminal 30 is further configured, when performing the additional measurement reporting, to include in the measurement report 46, as the measurement result for the measurement object as measured by the user equipment unit from a neighbor cell, both the reference signal received power (RSRP) value and the reference signal received quality (RSRQ) value. In an example embodiment the user equipment unit 30 is further configured to exclude the measurement result for the measurement object as measured by the user equipment unit from a neighbor cell from the additional measurement reporting of the measurement report.

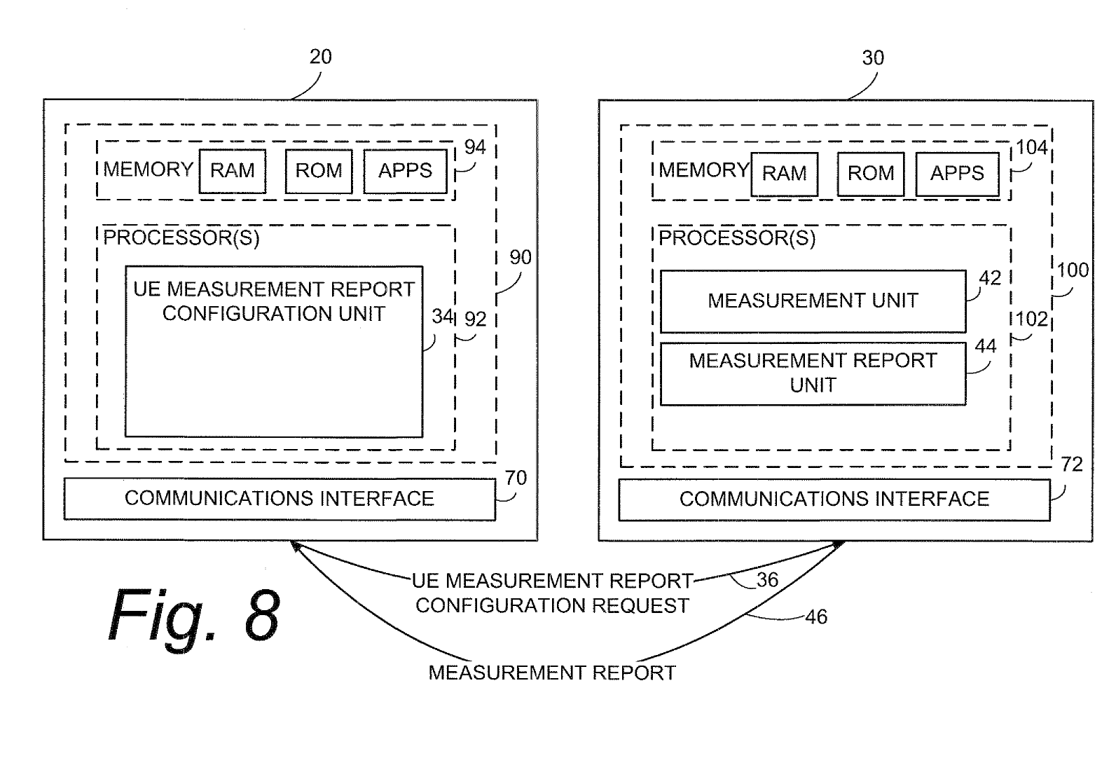

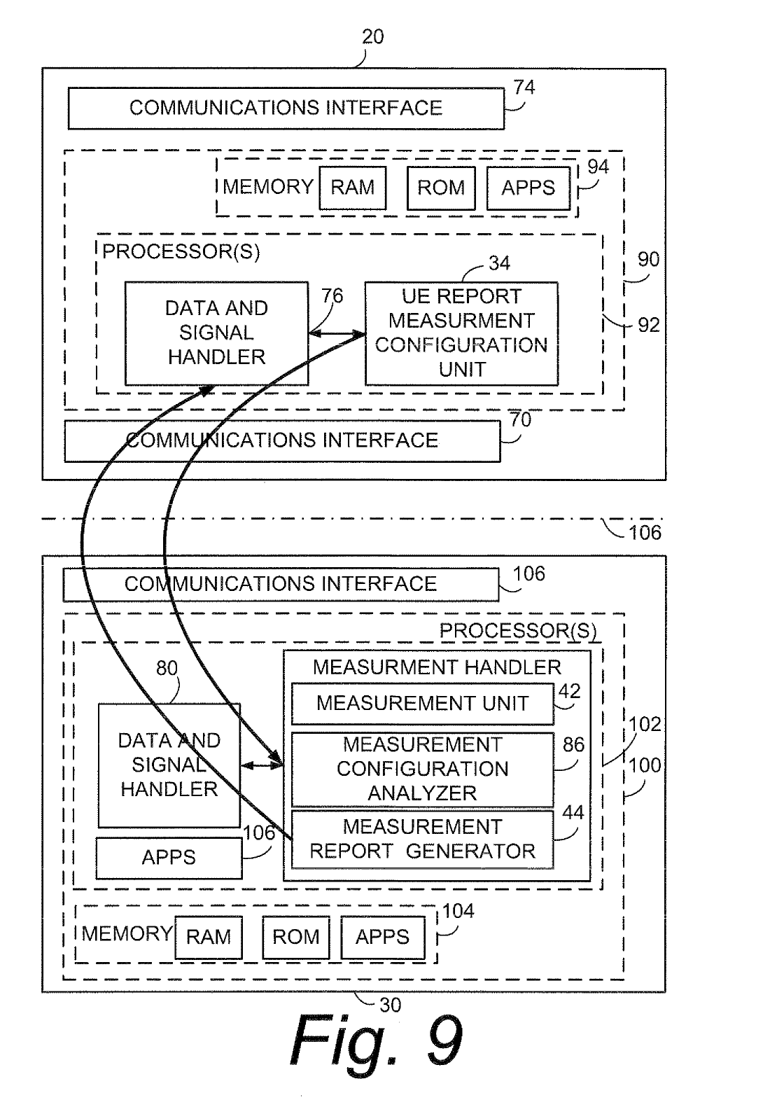

FIG. 8 illustrates that both network node 20 and user equipment unit (UE) 30 may include a communications interface, such as network node communications interface 70 and UE communications interface 72. The network node communications interface 70 enables network node 20 to communication over a radio or air interface with user equipment unit (UE) 30, on both uplink and downlink. Similarly, the UE communications interface 72 enables user equipment unit (UE) 30 to communicate over the radio or air interface with network node 20, on both uplink and downlink. The communication interfaces may connect to one or more antenna, and such communication(s) can employ any suitable frame or protocol structure.

It will be understood that both network node 20 and user equipment unit (UE) 30 may include or comprise other functional units not illustrated or described herein, but known to the person skilled in the art. For example, as show in FIG. 9, network node 20 may comprise another interface to other nodes of a radio access network (RAN) or to a core network, such as interface 74. In addition, network node 20 may comprise data and signal handler 76 which, e.g., formats information (e.g., in frames or packets) for transmission on a downlink (DL) over the air interface to user equipment unit (UE) 30 and deformats or processes information received on an uplink (UL) from user equipment unit (UE) 30.

FIG. 9 shows that user equipment unit (UE) 30 may, in an example embodiment, comprise other functionalities including data and signal handler 80 and various applications 82. The data and signal handler 80 may perform such functions as, e.g., formatting information (e.g., in frames or packets) for transmission on an uplink (UL) over the air interface to network node 20 and deformatting or processing information received on the downlink (DL) from network node 20, and in doing so may carry out the instructions or consequences of execution of one or more application programs 82. FIG. 9 further shows that the measurement result section 60 and additional measurement reporting section 62 may comprise a more generalized functionality such as measurement handler 84, and that measurement handler 84 may also comprise measurement configuration request analyzer 86.

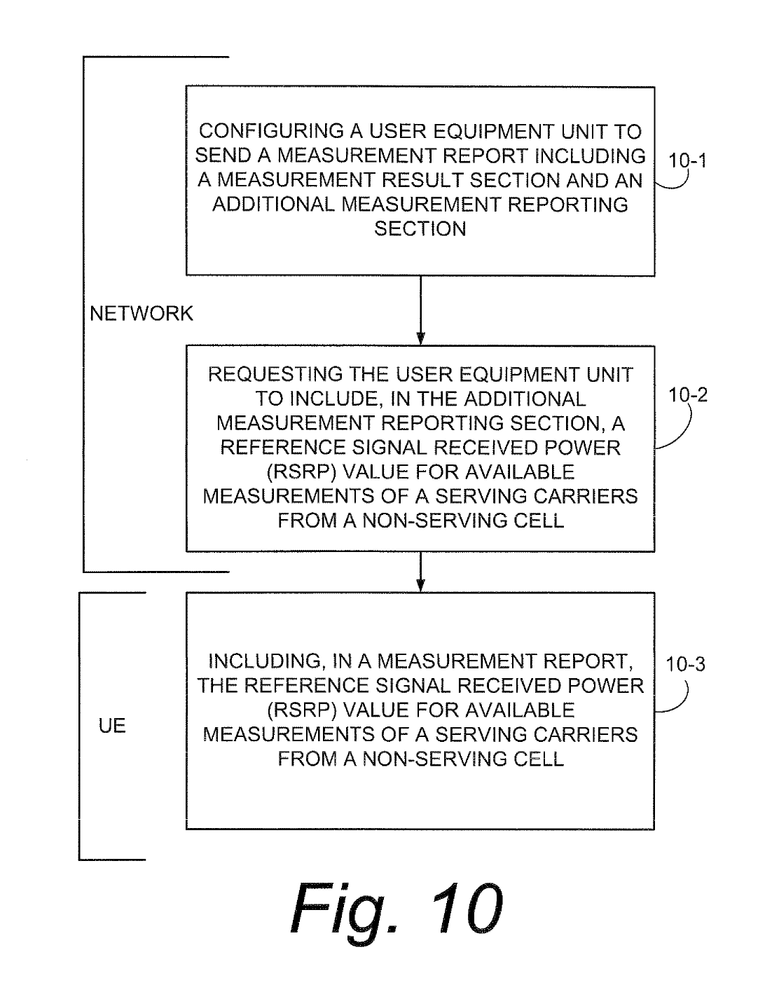

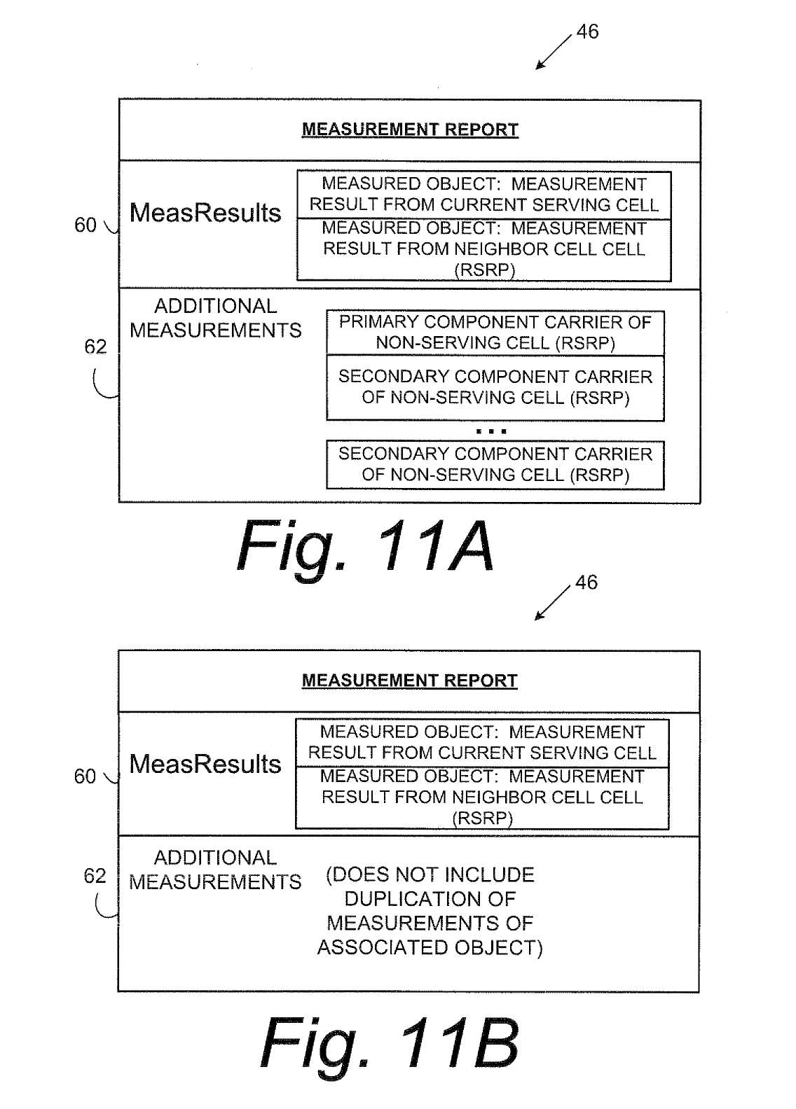

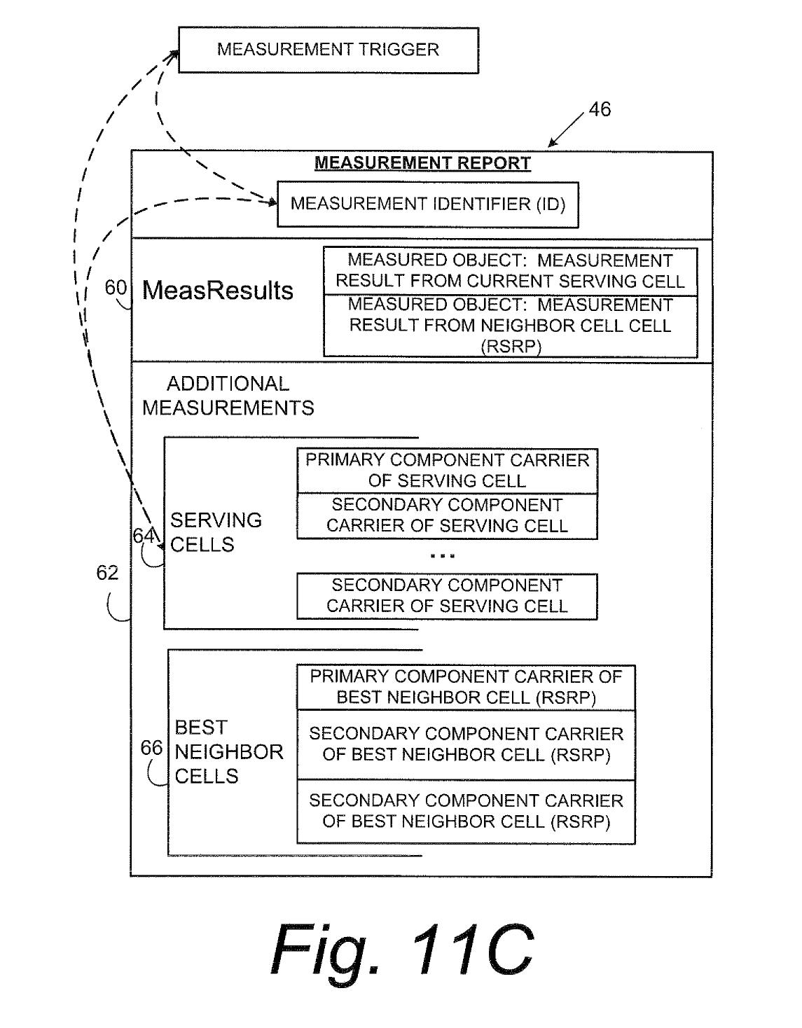

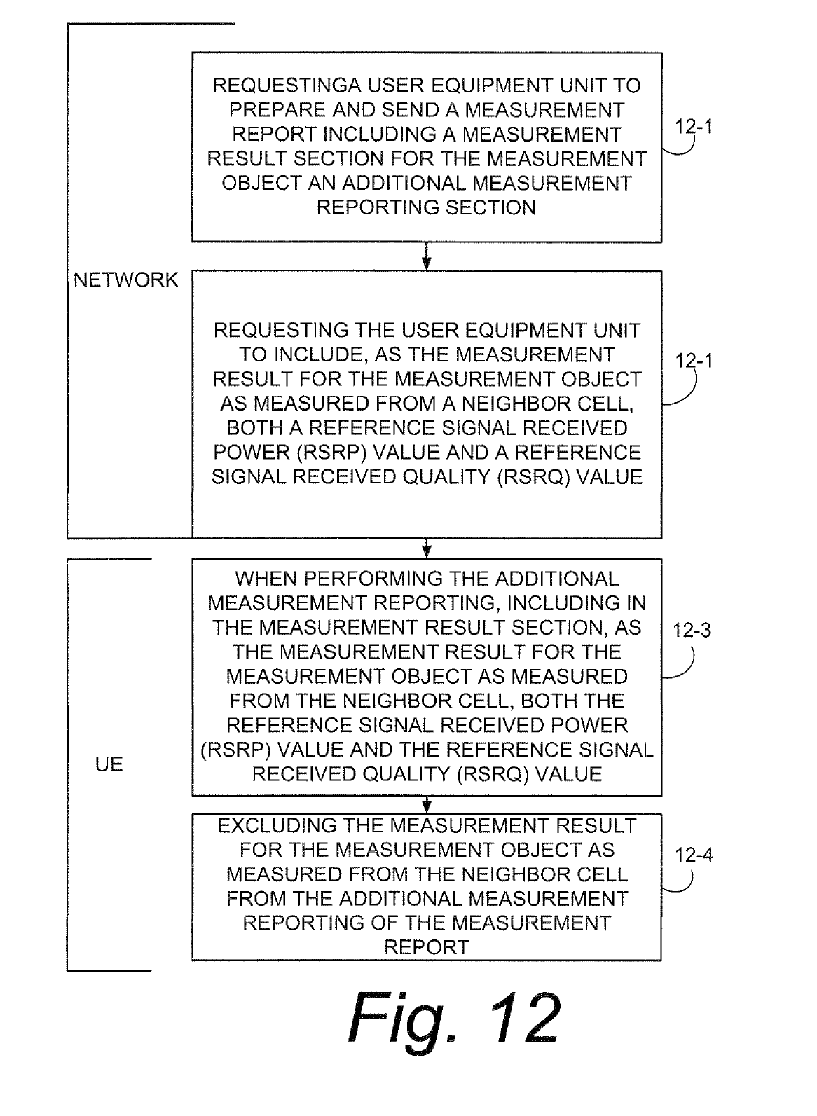

FIG. 10 illustrates basic, representative, non-limiting acts or steps of a first example method of operating a communications network. The first example method of FIG. 10, and a second example method of FIG. 12, both include formatting the measurement report 46 to include measurement result section 60 and additional measurement reporting section 62, as illustrated in simplified fashion by FIG. 11A. The measurement result section 60 includes both (a) a measurement result for the measurement object as measured from a current serving cell and a measurement result for the measurement object as measured by the user equipment unit from a neighbor cell. The additional measurement reporting section 62 includes, possibly among other measurements, measurements of serving frequencies from one or more non-serving cells.

Act 10-1 of the first method of FIG. 10 comprises the network (e.g., the network node) requesting (e.g., configuring) the user equipment unit 30 to prepare and send a measurement report to the network concerning a measurement object for which the measurement report is to be triggered. In an example embodiment act 10-1 essentially comprises the network requesting or configuring the user equipment unit 30 to prepare and send the measurement result section 60 and additional measurement reporting section 62 of the measurement report 46. In particular, as act 10-1 the network requests/configures the UE 30, and thus the measurement report 46, to include (a) a measurement result for the measurement object as measured from a current serving cell and a measurement result for the measurement object as measured by the user equipment unit from a neighbor cell; and (b) additional measurement reporting including measurements that are available at the user equipment unit from multiple serving carriers. Act 10-2 comprises the network requesting/configuring the user equipment unit to include, in the additional measurement reporting (e.g., in additional measurement reporting section 62 of measurement report 46), a reference signal received power (RSRP) value for an available measurement of a serving carrier from a non-serving cell. In an example embodiment and mode, both act 10-1 and 10-2 are preferably accomplished in a same message to user equipment unit (UE) 30, such as the UE measurement report configuration request 36.

Whereas act 10-1 and act 10-2 are performed by the network (e.g., by network node 28), act 10-3 is performed by user equipment unit (UE) 30. Act 10-3 comprises the user equipment unit, when performing the additional measurement reporting, including in the additional measurement reporting section 62 of the measurement report, the reference signal received power (RSRP) value for an available measurement of a serving carrier from a non-serving cell.

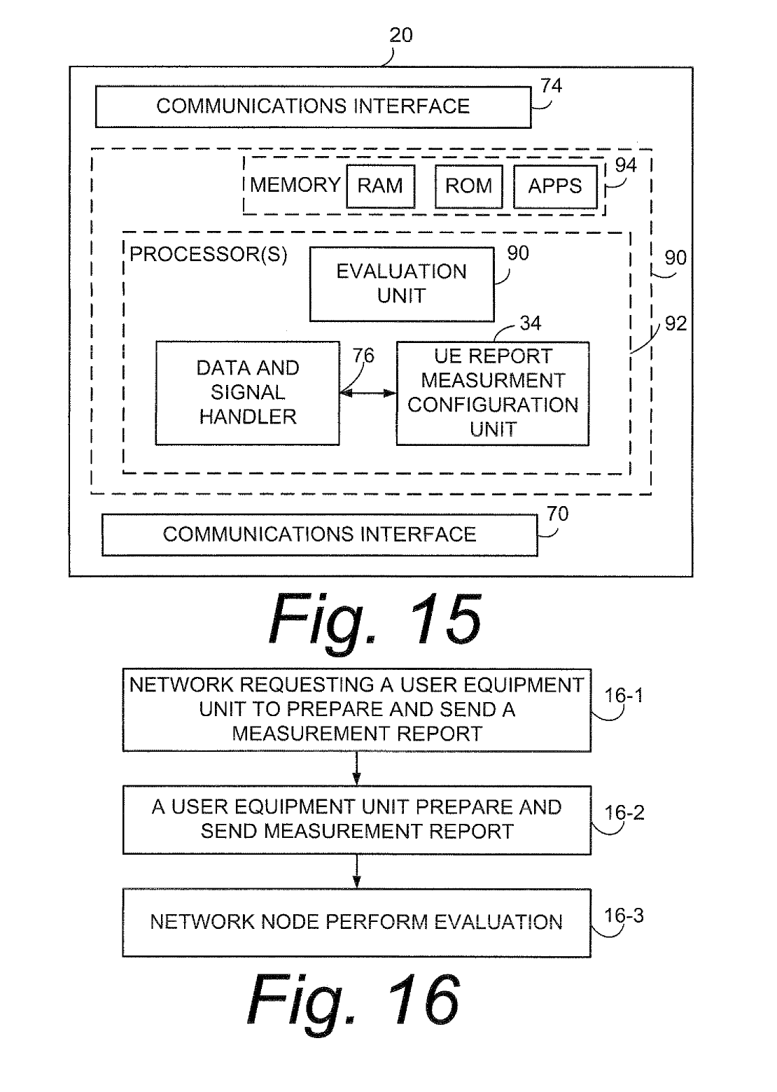

As is understood, e.g., with reference to FIG. 15 and FIG. 16, the use of the referenced signal received power (RSRP) value(s) within the additional reporting (e.g., in additional measurement reporting section 62) for the available measurements of the serving carriers from one or more non-serving cells facilitates best cell evaluation within a carrier.

Thus, while describing a basic method of operating a communications network, FIG. 10 also describes both a basic method of operating a network node and a basic method of operating a user equipment unit (UE). In this regard, act 10-1 and act 10-2 comprise example acts or steps of a first basic method of operating a network node, while act 10-3 comprise an example act or step of a first basic method of operating a user equipment unit (UE). The first basic method of operating a communications network, the first basic method of operating a network node, and the first basic method of operating a user equipment unit (UE) as shown in FIG. 10 are all collectively referred to as the “first basic methods”.

The first basic methods also encompass various ways of formatting the measurement report. As mentioned above, the basic methods may include formatting the measurement report 46 (e.g., as in FIG. 11A) to include measurement result section 60 and additional measurement reporting section 62. The additional measurement reporting section 62 includes, possibly among other measurements, measurements of serving frequencies from one or more non-serving cells. According to the first basic methods, the measurement of the serving frequencies from one or more non-serving cells are expressed by a reference signal received power (RSRP) value. By way of example, FIG. 11A shows the additional measurement reporting section 62 as a report subsection of measurements from non-serving cells (e.g., a measurement of the primary component carrier from a non-serving cell and measurements of one or more secondary component carriers from their respective non-serving cells). In an example implementation the non-serving cells reported in the additional measurement reporting section 62 may be best neighbor cells.

FIG. 12 illustrates basic, representative, non-limiting acts or steps of another or second method of operating a communications network. Act 12-1 comprises the network requesting (e.g., configuring) the user equipment unit 30 to send a measurement report to the network concerning a measurement object for which the measurement report is to be triggered. In an example embodiment act 11-1 essentially comprises the network requesting/configuring the user equipment unit 30 to prepare and send the measurement result section 60 and additional measurement reporting section 62 of the measurement report 46. In particular, as act 12-1 the network configures the UE 30, and thus the measurement report 46, to include (a) a measurement result for the measurement object as measured from a current serving cell and a measurement result for the measurement object as measured by the user equipment unit from a neighbor cell; and (b) additional measurement reporting including measurements that are available at the user equipment unit from multiple serving carriers. Act 12-2 comprises the network requesting/configuring the user equipment unit 30 to include, in the measurement result section 60 but not in the additional measurement reporting section 62, both a reference signal received power (RSRP) value and a reference signal received quality (RSRQ) value for the measurement result for the measurement object as measured by the user equipment unit from a neighbor cell. In an example embodiment and mode, both act 12-1 and 12-2 are preferably accomplished in a same message to user equipment unit (UE) 30, such as the UE measurement report configuration request 36.

Whereas act 12-1 and act 12-2 are performed by the network (e.g., by network node 28, act 12-3 and 12-4 are performed by user equipment unit (UE) 30. Act 12-3 comprises the user equipment unit, when performing the additional measurement reporting, including in the measurement report (in the measurement result section 60), both the reference signal received power (RSRP) value and the reference signal received quality (RSRQ) value for the measurement result for the measurement object as measured by the user equipment unit from a neighbor cell. Act 12-4 comprises the wireless terminal excluding the measurement result for the measurement object as measured by the user equipment unit from a neighbor cell from the additional measurement reporting of the measurement report.

Thus, while describing a second basic method of operating a communications network, FIG. 12 also describes both a second basic method of operating a network node and a second basic method of operating a user equipment unit (UE). In this regard, act 12-1 and act 12-2 comprise example acts or steps of a second basic method of operating a network node, while act 12-3 and act 12-4 comprise example acts or steps of a second basic method of operating a user equipment unit (UE). The second basic method of operating a communications network, the second basic method of operating a network node, and the second basic method of operating a user equipment unit (UE) as shown in FIG. 12 are all collectively referred to as the “second basic methods”.

The first basic methods and the second basic methods are collectively referred to as the “basic methods”. Moreover, it should be understood that acts of the first basic methods may, in non-limiting example embodiments and modes, be included in the second basic methods. Such acts of the first basic methods which may be included in the second basic methods include, e.g., acts such as act 10-2 (the network requesting/configuring the user equipment unit to include, in the additional measurement reporting, a reference signal received power (RSRP) value for an available measurement of a serving carrier from a non-serving cell) and/or act 10-3 (the user equipment unit, when performing the additional measurement reporting, including in the measurement report, the reference signal received power (RSRP) value for an available measurement of the serving carrier from the non-serving cell).

The basic methods encompass other example embodiments and modes, including various modifications and implementations. For example, the associated measurement object as measured from the neighbor cell may be anyone of the following: (1) a same frequency as the measurement object; (2) a different frequency than the measurement object; or (3) provided by a different radio access technology than the measurement object.

The second basic methods also encompass various ways of formatting the measurement report. For example, the basic methods may include formatting the measurement report 46 as in FIG. 11B to include measurement result section 60 and additional measurement reporting section 62, and including the reference signal received power (RSRP) value and the reference signal received quality (RSRQ) value for the measurement result for the measurement object as measured by the user equipment unit from a neighbor cell in the measurement result section 60. However, the measurement report 46 is prepared or formatted so as not to include the measurement result for the measurement object as measured by the user equipment unit from a neighbor cell in the additional measurement reporting section 62.

As another example, the second basic methods also encompass example embodiments and modes wherein the measurement object is linked by a measurement identity to a measurement trigger, such linking being illustrated by broken lines in FIG. 11C. In such example embodiments and modes the basic methods may also be modified or augmented to comprise (1) including in the measurement identity a list of serving frequencies which are linked to the measurement trigger; and (2) for each of the serving frequencies on the list including in the additional measurement reporting a measurement from a non-serving cell (other than a serving frequency corresponding to the measurement object). In an example implementation the measurement for each of the serving frequencies from a non-serving cell is from a best non-serving cell, and the measurement for each of the serving frequencies, including the measurement of the serving frequencies from a non-serving cell, is a reference signal received power (RSRP) value. By way of example, FIG. 11C shows the additional measurement reporting section 62 as comprising report subsection 64 of measurements from serving cells and report subsection 66 of measurements from best neighbor cells (e.g., a measurement of the primary component carrier from a best neighbor cell and measurements of one or more secondary component carriers from their respective best neighbor cells). As also shown by the broken lines in FIG. 11C, the measurement identity also links the measurement trigger to a list of serving frequencies (e.g., the frequencies of the serving cells of report subsection 64).

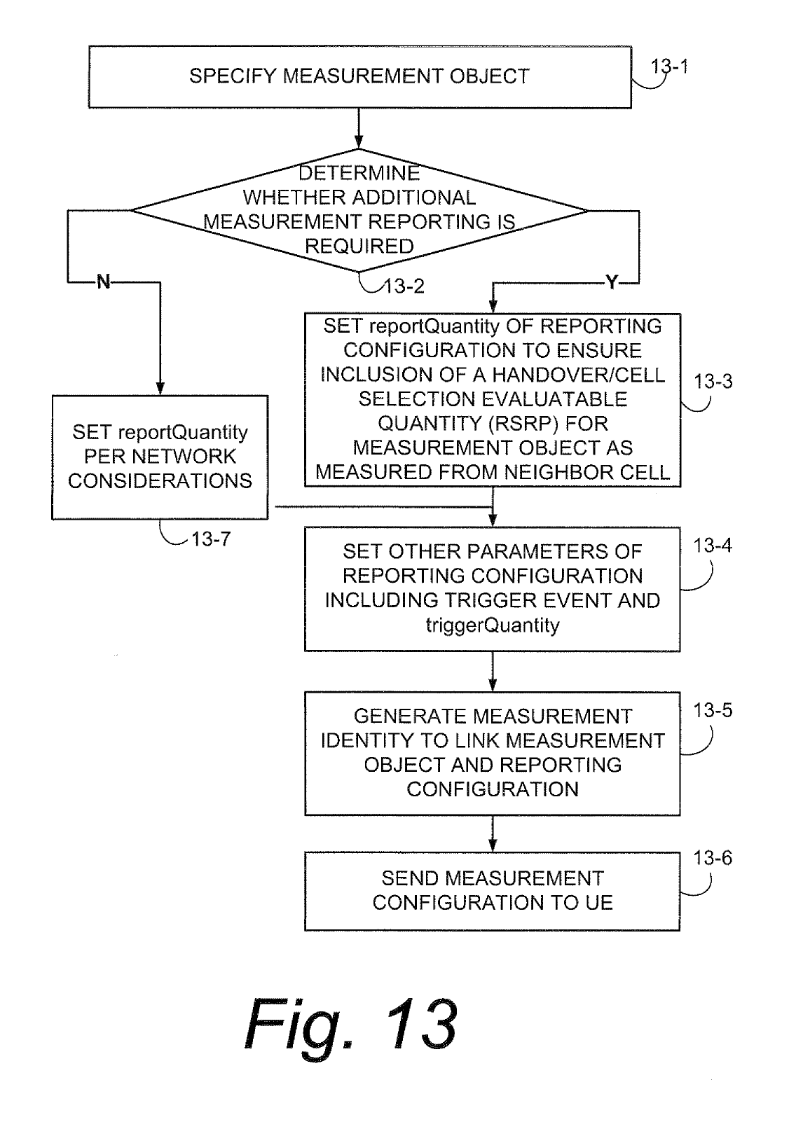

While FIG. 12 shows general, representative acts or steps in the second basic methods, FIG. 13 shows in more detail example acts which, in an example implementation, collectively comprise act 12-1 and act 12-2, and which particularly illustrate an example embodiment and mode of preparing a UE measurement report configuration request 36 and thus for configuring the user equipment unit (UE) 30. Act 13-1 comprises specifying a measurement object, e.g., a frequency of a component carrier for which the network requires one or more measurement reports. For example, the measurement object may be a frequency of a primary component carrier from a serving cell (PCell). The measurement object may also correspond, e.g., to a frequency of a component carrier from a neighbor cell (e.g., NeighCell).

Act 13-2 comprises the network determining or checking whether the additional measurement reporting (reporting beyond the information normally provided by measurement result section 60, e.g., the reporting of additional measurement reporting section 62) is to be required. The RAC (Radio Access Control) unit in the base station decides whether additional measurements are needed for handover and carrier management purposes. If the determination of act 13-2 is affirmative, then as act 13-3 the network node sets an information element of the UE measurement report configuration request 36 (e.g., the reportQuantity information element) to ensure inclusion in the measurement report 46 of a handover/cell selection evaluatable quantity (RSRP) for the measurement result for the measurement object as measured by the user equipment unit from a neighbor cell. In an example implementation, the information element reportQuantity information element is set to “both”, to ensure that both the RSRP and RSRQ values will be reported for the measurement result for the measurement object as measured by the user equipment unit from a neighbor cell.

Act 13-4 comprises setting other parameters of a Report Configuration information element (ReportConfig) of the UE measurement report configuration request 36. Such other parameters as set or established in the Report Configuration information element (ReportConfig) may include a trigger event and triggerQuantity, in respective information elements which comprise the Report Configuration information element.

Act 13-5 comprises generating a Measurement Identity to link Measurement Object (as specified by act 13-1) and the Reporting Configuration (as specified, e.g., by act 13-4). Act 13-6 comprises sending the measurement report 46 (which includes the including Measurement Identity, Measurement Object, and Reporting Configuration) to user equipment unit (UE) 30.

If It were determined at act 13-2 that the additional measurement reporting is not to be required, then as act 13-7 the information element reportQuantity can be set other than as in act 13-3, e.g., in accordance with other network considerations or preferences (and thus not necessarily to require a reporting of RSRP for the measurement result for the measurement object as measured by the user equipment unit from a neighbor cell). Act 13-7 is then followed by act 13-4 through act 13-6, each of which is understood from the foregoing.

A non-limiting example of contents of the Report Configuration information element included in the UE measurement report configuration request 36 is illustrated in Table 1. Such Report Configuration information element may in turn comprise further information elements. In the Report Configuration information element of Table 1, the information element “triggerType” corresponds to or encompasses one or more of the trigger events. The Report Configuration information element of Table 1 also includes the triggerQuantity and the reportQuantity information elements as set by the network. In accordance with the technology disclosed herein, the reportQuantity information element is set to “both” to specify that both RSRP and RSQQ are to be reported. The information element “report AddNeightMeas-r10” may be set to require the additional measurement reporting.

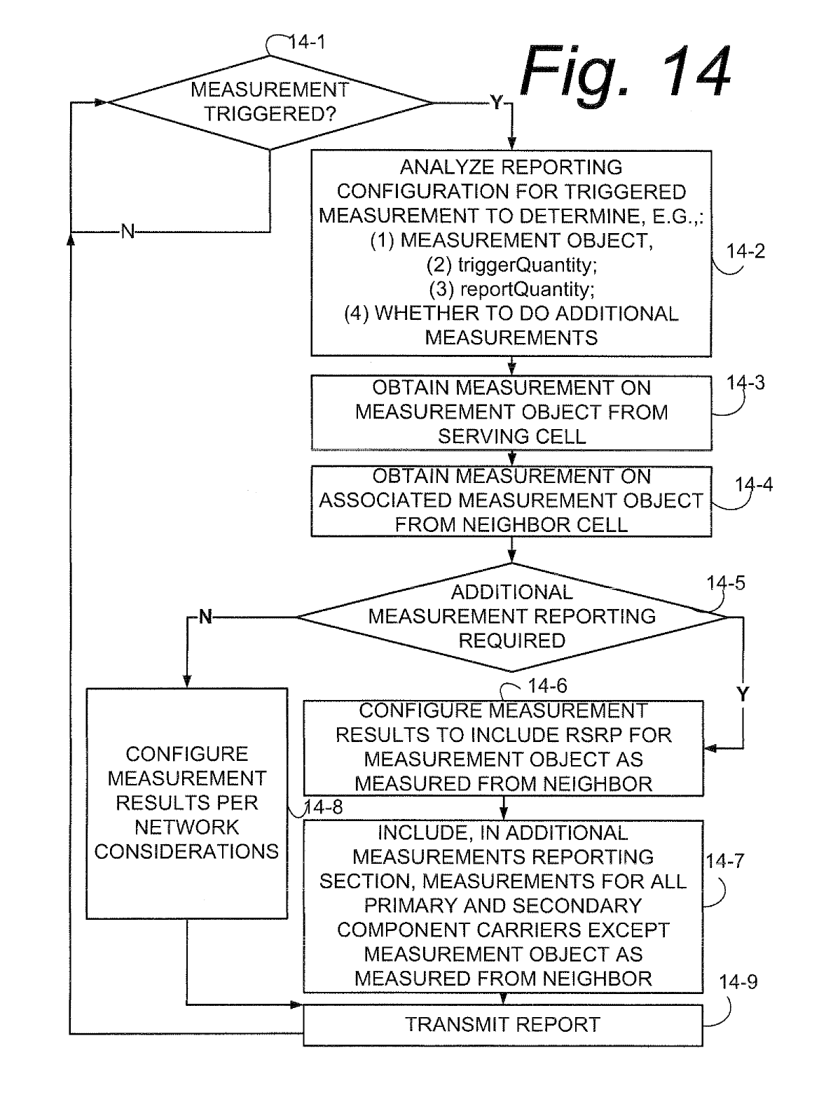

While FIG. 12 shows representative acts or steps in the basic methods, FIG. 14 shows in more detail example acts which, in an example implementation, collectively comprise act 12-3 and act 12-4, and which particularly illustrate an example embodiment and mode of operating the user equipment unit (UE) 30. Act 14-1 comprises the user equipment unit (UE) 30 detecting or otherwise determining whether it is time to make a measurement according to a UE measurement report configuration request 36, e.g., that a measurement has been triggered. If a measurement has not been triggered, the user equipment unit (UE) 30 keeps checking for or awaiting a next measurement triggering event (as indicated by the negative decision arrow back to act 14-1).

If a measurement has been triggered, as act 14-2 the user equipment unit (UE) 30 checks the report configuration information element of the UE measurement report configuration request 36 associated with measurement identity which is linked to the trigger. The checking of act 14-2 can be performed by measurement configuration request analyzer 86 (see FIG. 9). The report configuration information element of the UE measurement report configuration request 36 is checked in act 14-2 to determine several items of information, e.g., the measurement object (e.g., what component carrier frequency is to be measured); the setting for the information element “triggerQuantity” (the user equipment unit (UE) 30 starts the measurements once it receives the measurement configuration and the report get triggered when the trigger condition is met); the setting for the information element “reportQuantity”; and, whether the network has requested that user equipment unit (UE) 30 perform the additional measurements (e.g., whether the “reportAddNeighMeas-r10” information element has been set in Table 1, for example).

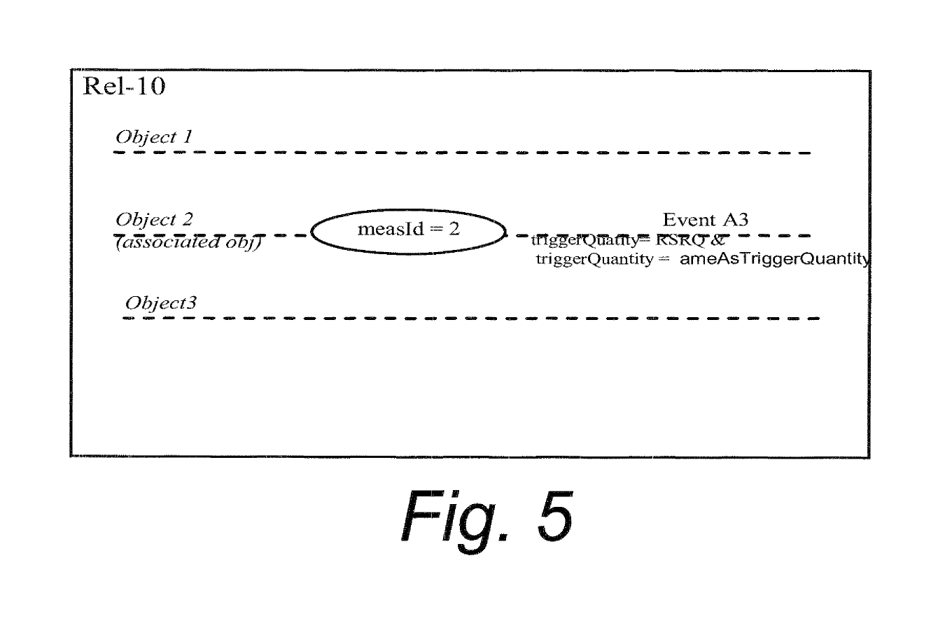

Act 14-3 comprises the user equipment unit (UE) 30 (e.g., measurement unit 42) making the measurement on the measurement object. The measurement of the measurement object may be performed by measurement unit 42. The measurement object may be any frequency, e.g., any frequency which is a primary component carrier or a secondary component carrier for the connection or session in which the UE 30 is currently participating. In some instances the measurement object will be the frequency of a component carrier transmitted from a serving cell, such as primary component carrier transmitted from a serving cell (PCell). In any event, the network needs to know whether the serving cell should remain the serving cell or whether the measurement of the frequency of the component from the serving cell has been exceeded by a measurement of the counterpart frequency from a neighbor cell (e.g., NeighCell), essentially in the manner illustrated in FIG. 3, so that there should be a handover of the component carrier to the neighbor cell (and so that the neighbor cell would become the serving cell). For this reason as act 14-4 the measurement unit 42 also measures the measurement object from a neighbor cell, e.g., measures the component carrier as obtained from a neighbor [e.g., the best neighbor] non-serving cell).

As act 14-5 the UE 30 determines from UE measurement report configuration request 36 whether the additional measurements reporting is required. Such determination can be performed, in an example embodiment, by measurement configuration request analyzer 86. The determination of act 14-5 may be performed, for example, by checking the value of the “reportAddNeighMeas-r10” information element as shown in Table 1. If the additional measurements reporting is required, as act 14-6 the UE 30 configures the measurement results section 60 of the measurement report 46 (see FIG. 11B) to ensure that RSRP is reported for the associated measurement object. In this regard, in an example implementation the UE 30 considers the information element “reportQuantity” to be set to “both”, so that both RSRP and RSRQ are reported for the associated measurement object.

In addition, if the additional measurements reporting is required, as act 14-7 the UE 30 (e.g., measurement report unit 44) configures the additional measurement reporting section 62 of the measurement report 46. For example, UE 30 configures the additional measurement reporting section 62 of the measurement report 46 to include currently available measurements for all primary component carriers and all secondary component carriers of interest to the UE 30 for the current connection or session. The measurements included as act 14-7 are not necessarily and are preferably not specially commissioned or required by the triggering event, but are measurements that the measurement unit 42 has on-hand at the time of occurrence of the triggering event or generation of the measurement report 46. The currently available measurements for all primary component carriers and all secondary component carriers may include measurements from the serving cells for the component carriers and non-serving cells for the component, e.g., best non-serving cells for the component carriers, as illustrated in additional measurement reporting subsection 66 of FIG. 11C. However, if such additional measurements could be construed to encompass a measurement result for the measurement object as measured by the user equipment unit from a neighbor cell, the measurement result for the measurement object as measured by the user equipment unit from a neighbor cell is filtered out (e.g., omitted) from the additional measurement reporting section 62. Thus, as act 14-7 the UE 30 excludes the measurement result for the measurement object as measured from the neighbor cell from the additional measurement reporting section of the measurement report, so that the measurement result for the measurement object as measured from the neighbor cell appears only once in the measurement report.

If the additional measurements reporting is not required, as act 14-8 the UE 30 (e.g., measurement report unit 44) configures the measurement report 46 not to include the additional measurement reporting subsection 66. Further, as depicted by act 14-8, the UE 30 configures the measurement reporting of the measurement result for the measurement object as measured by the user equipment unit from a neighbor cell without regard to whether the measurement quantity reported can be used for handover evaluation. In other words, the UE user equipment unit (UE) 30 does not undertake special effort to assure that the measurement quantity reported is RSRP, but instead by default or otherwise reports the measurement result for the measurement object as measured by the user equipment unit from a neighbor cell in accordance with network preferences or conventions.

Act 14-9 comprises the UE user equipment unit (UE) 30 sending the measurement report 46 to the network on the uplink (UL). Such sending or transmission may be implemented by UE communications interface 72. A non-limiting example of information elements included in the measurement results report (e.g., measurement report 46, also known as the MeasResults) is illustrated in Table 2. Such MeasResults information element may in turn comprise further information elements. Non-limiting example of instructions that can be used to generate the additional measurement reporting section 62 (MeasResultServFreqList-r10) of an example measurement report 46 are also shown in Table 2.

In terms of parlance of the Table 2 and other tables and/or information elements described herein, there is a corresponding information element MeasResultsNeighCells defined for each measObject type (e.g., one for EUTRA, one for UTRA, one for GERAN, and one for CDMA). The MeasResultsNeighCells contains the measurement results of the associated measurement object. The measObject is linked to a certain carrier frequency. The measResultServFreqList includes the measurement results of the current serving cell (measResultSCell) and the additional measurement (measResultBestNeighCell) of a UE. The additional measurements reporting is included in the measResultServFreqList-r10 information element. The measurement identity (measId) that triggered the measurement reporting is associated with a reportConfig information element of the UE measurement report configuration request 36, and it is assumed that the reportConfig information element included a reportAddNeightMeas information element which required the additional measurement reporting.

The network assigns a unique measurement identity (measId) when the network links a measurement object (identified by a measurement object identifier [measObjectId]) to a measurement event. By reference to the measurement identity the network knows which event and measurement object combination triggers a particular measurement report. The assigning of the measurement identity may be accomplished through an information element (such as a MeasIdToAddMod information element) which specifies or links the measurement identity (measId) with the measurement object identifier [measObjectId]) and the report configuration identifier (reportConfigId). The measurement object identifier [measObjectId]) is assigned to each frequency; the report configuration identifier (reportConfigId) is defined for each report. Thus, the network assigns a unique measurement identity (measId) measurement object and the measurement identifier, so that when the network receives a report, the network knows how to map a measurement object to the event which triggered the report.

FIG. 15 and FIG. 16 illustrate another embodiment and mode of operation in which the network node 20 further comprises evaluation unit 90. The evaluation unit 90 is configured to perform a best cell evaluation for a carrier using one or more signal received power (RSRP) values included in the measurement report. Act 16-1 of FIG. 16 depicts the network requesting (e.g., configuring) the user equipment unit 30 to prepare and send a measurement report, e.g., in the manner of act 10-1 and 10-2 of the first basic method of FIG. 10, or in the manner of act 12-1 and 12-2 of the second basic method of FIG. 12. Act 16-2 comprises the user equipment unit 30 preparing and sending the measurement report, e.g., in the manner of act 10-3 of the first basic method of FIG. 10, or in the manner of act 12-3 and 12-4 of the second basic method of FIG. 12. Act 16-3 comprises the network node performing a best cell evaluation for a carrier using one or more signal received power (RSRP) values included in the measurement report. For example, as act 16-3 the network node may perform a best cell evaluation using the measurement result for the measurement object as measured by the user equipment unit from a neighbor cell.

FIG. 8 is again referenced as a more detailed schematic view of a communications system such as both or either that of FIG. 6 or FIG. 7, showing not only the functionalities previously described but also showing by broken lines an example optional platform or machine implementation. For example FIG. 8 illustrates that UE measurement report configuration unit 34 of the network node of either the embodiment of FIG. 6 or the embodiment of FIG. 7 may be provided on a machine platform 90. The machine platform 90 may any of several forms, such as (for example) electronic circuitry in the form of, e.g., a computer implementation platform or a hardware circuit platform. FIG. 8 particularly shows machine platform 90 as being a computer platform wherein logic and functionalities of UE measurement report configuration unit 34 are implemented by one or more computer processors or controllers 92 as those terms are herein expansively defined. In such a computer implementation the machine platform 90 may comprise, in addition to a processor(s) 92, memory section 94 (which in turn may comprise random access memory; read only memory; and application memory (which stores, e.g., coded instructions which may be executed by the processor to perform acts described herein); and any other memory such as cache memory, for example).

In similar manner as the network node 20, as also illustrated by broken lines the wireless terminal 30 may also optionally comprise a platform 100. The platform 100 of wireless terminal 30 may also take of several forms, such as (for example) electronic circuitry in the form of, e.g., a computer implementation platform or a hardware circuit platform. FIG. 8 again particularly shows machine platform 100 as being a computer platform wherein logic and functionalities of measurement unit 42 and measurement report unit 44 are implemented by one or more computer processors or controllers 102 as those terms are herein expansively defined. In such a computer implementation the machine platform 100 may also comprise, in addition to a processor(s) 102, memory section 104.

FIG. 9 also shows, by broken lines, how its embodiment can be implemented by machine (e.g., electronic circuit) platform, using similar reference numerals as FIG. 8. The machine platform implementation may also be applicable to the embodiment of FIG. 15, as well as other embodiments encompassed hereby.

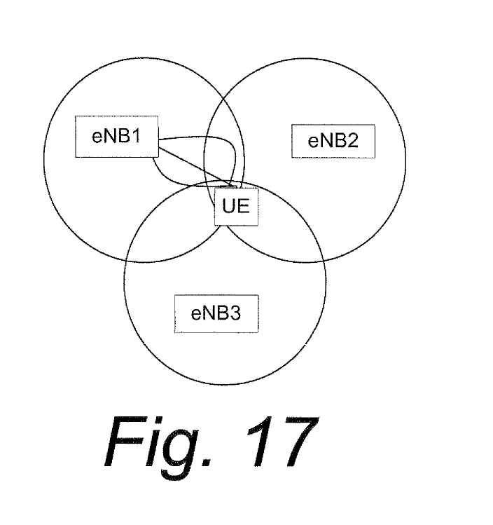

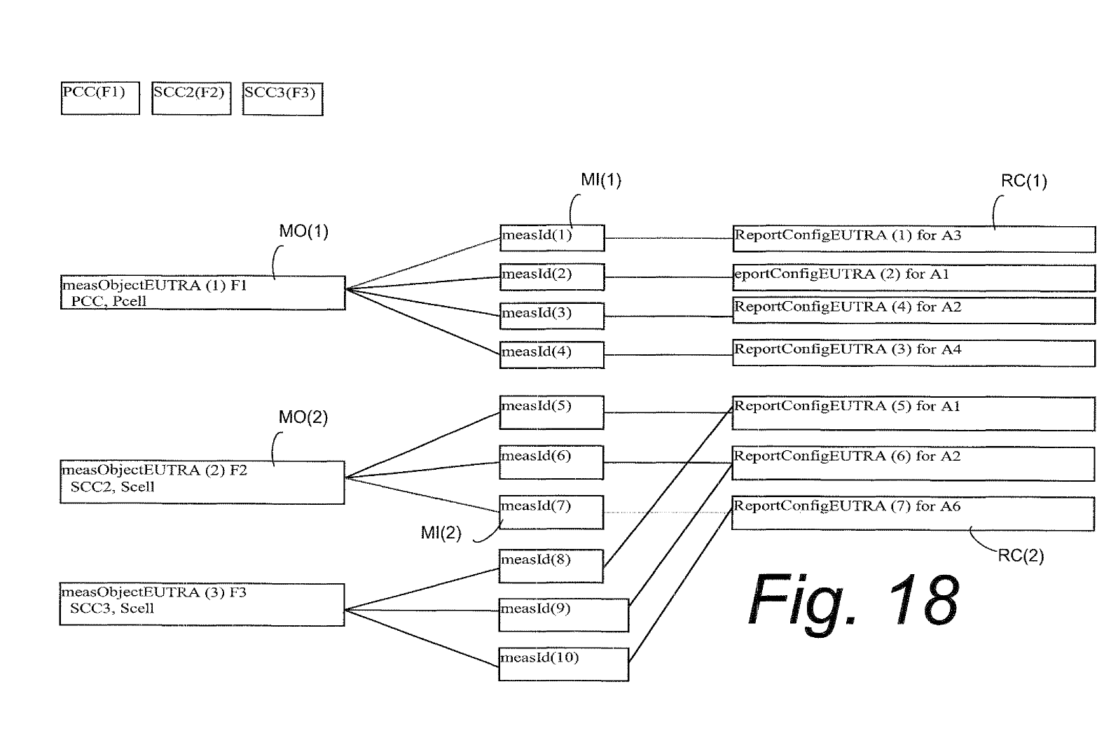

FIG. 17 and FIG. 18 illustrate an example deployment scenario with three carriers. In particular, eNB1 as shown in FIG. 17 has three carriers PCC(F1), SCC1(F2) and SCC2(F3). The UE is configured with event A3 (on PCC). The UE measures on all the carriers PCC, SCC1 and SCC2. FIG. 17 and FIG. 18 serve as a basis for discussion of two example cases, e.g., case 1 and case 2. In FIG. 18, for case 1 a linkage is shown between measurement object MO(1), measId MI(1), and report configuration RC(1); and for case 2 another linkage is shown between measurement object MO(2), measId MI(2), and report configuration RC(2).

Case 1 assumes that the event A3 on PCC meets the entry criteria and the UE is going to send a measurement report triggered by A3 on PCC. So the measurement object is: measObjectEUTRA (1) on the PCC (F1). But the UE may have measurements available on the other carriers as well since it is going to performing measurements on SCC2 & SCC3 as well. So the additional measurement are best neighbours available on SCC2 and SCC3 linked to measurement objects measObjectEUTRA (2) on the SCC2 (F2) & measObjectEUTRA (3) on the SCC3 (F3). There is no additional measurement from the PCC will be included since it has already available from the information element measResultNeighCells (see Table 2).

For case 1, the information element MeasResultListEUTRA (see Table 2) includes all the neighbor cells from eNB2 and eNB2 on carrier F1. The MeasResultServFreqList information element (see Table 2) will include the measurement result of each SCell, if any, and of the best neighboring cell on each serving frequency. For the frequency indicated in the measObject associated with the measurement, the best neighbor cell is not included in the MeasResultServFreqList information element. For each cell that is included the user equipment unit provides the layer 3 filtered measurement results. Table 3 thus reflects (in simplified form) example reporting for case 1.

Case 2 assumes that the event A6 on SCC2 meets the entry criteria and the UE is going to send a measurement report triggered by event A6 on SCC2. So the associated measurement object for case 2 is measObjectEUTRA (2) on the SCC2 (F2). But the UE may have measurements available on the other carriers as well since it is going to performing measurements on PCC & SCC3 as well. So the additional measurement are best neighbours available on PCC and SCC3 linked to measurement objects measObjectEUTRA (1) on the SCC2 (F1) & measObjectEUTRA (3) on the SCC3 (F3). There is no additional measurement from the SCC2 will be included since it has already available from measResultNeighCells (see Table 2). The measResltPcell field of Table 2 is a mandatory filled and is always filled with PCell measurements. Thus, the PCell is reported for case 2. Table 3 reflects (in simplified form) example reporting for case 2. The report for case 2 has measurement results for serving frequencies (PCC in measResltPcell and all the SCCs in measResultSCell), and the best neighbors for all the serving cells but excluding the carrier that triggered the report are in the measResultBestNeighCell information element. For Case2, SCC2 gets excluded; if the measurement object linked to PCC triggered the report, then best neighbor of PCC is excluded.

The network node 20 may be any network node suitable for sending a UE measurement report configuration request to the wireless terminal, e.g., a base station node (BS, eNodeB, for example) or a radio network controller (RNC) node. The nature of the communications interface 70 employed by network node 20 thus depends on the type of node which performs the function of the network node.

The wireless terminal may be called by other names and comprise different types of equipment. For example, the wireless terminal may also be called a mobile station, wireless station, or user equipment units (UEs), and may be equipment such as mobile telephones (“cellular” telephones) and laptops with mobile termination, and thus may be, for example, portable, pocket, hand-held, computer-included, or car-mounted mobile devices which communicate voice and/or data with radio access network.

There are several advantages to the technology disclosed herein, including but not limited to the following:
The size of the measurement report is not increased unnecessarily as it could be critical especially when the UE is in bad radio condition. It may cause RLF and further the UE loses the RRC connection since the measurement report use RLC AM.
Both the RSRP and RSRQ would be available to the network to enable the PCell and Scells selection at handover.
Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

TABLE 1
EXAMPLE REPORT CONFIGURATION INFORMATION ELEMENT

| | |
|---|---|
| -- ASN1START | |
| ReportConfigEUTRA ::= | SEQUENCE { |
| triggerType | CHOICE { |
| event | SEQUENCE { |
| eventId | CHOICE { |
| eventA1 | SEQUENCE { |
| a1-Threshold | ThresholdEUTRA |
| }, | |
| eventA2 | SEQUENCE { |
| a2-Threshold | ThresholdEUTRA |
| }, | |
| eventA3 | SEQUENCE { |
| a3-Offset | INTEGER (−30..30), |
| reportOnLeave | BOOLEAN |
| }, | |
| eventA4 | SEQUENCE { |
| a4-Threshold | ThresholdEUTRA |
| }, | |
| eventA5 | SEQUENCE { |
| a5-Threshold1 | ThresholdEUTRA, |
| a5-Threshold2 | ThresholdEUTRA |
| }, | |
| ..., | |
| eventA6 | SEQUENCE { |
| a6-Offset | INTEGER (−30..30), |
| a6-ReportOnLeave | BOOLEAN |
| } | |
| }, | |
| hysteresis | Hysteresis, |
| timeToTrigger | TimeToTrigger |
| }, | |
| periodical | SEQUENCE { |
| purpose | ENUMERATED { |
| | reportStrongestCells, reportCGI} |
| } | |
| }, | |
| triggerQuantity | ENUMERATED {rsrp, rsrq}, |
| reportQuantity | ENUMERATED {sameAsTriggerQuantity, both}, |
| maxReportCells | INTEGER (1..maxCellReport), |
| reportInterval | ReportInterval, |
| reportAmount | ENUMERATED {r1, r2, r4, r8, r16, r32, r64, infinity}, |
| ..., | |
| [[ si-RequestForHO-r9 | ENUMERATED {setup} OPTIONAL, -- Cond |
| reportCGI | |
| ue-RxTxTimeDiffPeriodical-r9 | ENUMERATED {setup} OPTIONAL -- Need OR |
| ]], | |
| [[ reportAddNeighMeas-r10 | ENUMERATED {setup} OPTIONAL -- Need OR |
| ]] | |
| } | |
| ThresholdEUTRA ::= | CHOICE{ |
| threshold-RSRP | RSRP-Range, |
| threshold-RSRQ | RSRQ-Range |
| } | |
| -- ASN1STOP | |

TABLE 2
EXAMPLE MEASUREMENT RESULTS INFORMATION ELEMENT

| MeasResults ::= | SEQUENCE { | |
|---|---|---|
| measId | MeasId, | |
| measResultPCell | SEQUENCE { | |
| rsrpResult | RSRP-Range, | |
| rsrpResult | RSRQ-Range | |
| }, | | |
| measResultNeighCells | CHOICE { | |
| measResultListEUTRA | MeasResultListEUTRA, | |
| measResultListUTRA | MeasResultListUTRA, | |
| measResultListGERAN | MeasResultListGERAN, | |
| measResultsCDMA2000 | MeasResultsCDMA2000, | |
| ... | | |
| } | | OPTIONAL, |
| ..., | | |
| [[ measResultForECID-r9 | MeasResultForECID-r9 | OPTIONAL |
| ]], | | |
| [[ locationInfo-r10 | LocationInfo-r10 | OPTIONAL, |
| measResultServFreqList-r10 | MeasResultServFreqList-r10 | OPTIONAL |
| ]] | | |
| } | | |
| MeasResultListEUTRA ::= | SEQUENCE (SIZE (1..maxCellReport)) OF MeasResultEUTRA | |
| MeasResultEUTRA ::= SEQUENCE { | | |
| physCellId | PhysCellId, | |
| cgi-Info | SEQUENCE { | |
| cellGlobalId | CellGlobalIdEUTRA, | |
| trackingAreaCode | TrackingAreaCode, | |
| plmn-IdentityList | PLMN-IdentityList2 | OPTIONAL |

| | |
|---|---|
| } | OPTIONAL, |

| | | |
|---|---|---|
| measResult | SEQUENCE { | |
| rsrpResult | RSRP-Range | OPTIONAL, |
| rsrqResult | RSRQ-Range | OPTIONAL, |
| ..., | | |
| [[ additionalSI-Info-r9 | AdditionalSI-Info-r9 | OPTIONAL |
| ]] | | |
| } | | |
| } | | |

MeasResultServFreqList-r10 ::= SEQUENCE (SIZE (1..maxServCell-r10)) OF MeasResultServFreq-r10

| | | |
|---|---|---|
| MeasResultServFreq-r10 ::= | SEQUENCE { | |
| servFreqId | ServCellIndex-r10, | |
| measResultSCell | SEQUENCE { | |
| rsrpResultSCell | RSRP-Range, | |
| rsrqResultSCell | RSRQ-Range | |
| } | | OPTIONAL, |
| measResultBestNeighCell | SEQUENCE { | |
| physCellId | PhysCellId, | |
| rsrpResultNCell | RSRP-Range, | |
| rsrqResultNCell | RSRQ-Range | |
| } | | OPTIONAL, |
| ... | | |
| } | | |

TABLE 3
CASE 1 EXAMPLE REPORTING

| | | Scell on | SCell on |
|---|---|---|---|
| | PCell on PCC | SCC2 | SCC3 |
| measResultSCell | | included | included |
| measResultBestNeighCell | Not included, since | included | included |
| (This is the additional | this information is | | |
| measurement results) | already available in | | |
| | measResult- | | |
| | ListEUTRA. | | |

TABLE 4
CASE 2 EXAMPLE REPORTING

| | PCell | | SCell on |
|---|---|---|---|
| | on PCC | Scell on SCC2 | SCC2 |
| measResultSCell | | included | included |
| measResultBestNeighCell | included | Not get included | included |
| (This is the additional | | since this | |
| measurement results) | | information is | |
| | | already available in | |
| | | measResult- | |
| | | ListEUTRA. | |

1. A method of operating a node of a communications network comprising:
the node configuring a user equipment unit to prepare a measurement report concerning a measurement object, the measurement report including:
(a) a measurement result for the measurement object as measured from a current serving cell and a measurement result for the measurement object as measured from a neighbor cell;
(b) additional measurement reporting including measurements that are available at the user equipment unit from multiple serving carriers;
the node requesting that the user equipment unit include a reference signal received power (RSRP) value for the measurement result for the measurement object as measured from the neighbor cell.

2. The method of claim 1, further comprising:
the node requesting the user equipment unit to include both the reference signal received power (RSRP) value and a reference signal received quality (RSRQ) value for the measurement result for the measurement object as measured from the neighbor cell.

3. The method of claim 2, further comprising:
the node requesting the user equipment unit to send a message which sets a parameter reportQuantity to require the user equipment unit to include both the reference signal received power (RSRP) value and the reference signal received quality (RSRQ) value for the measurement result for the measurement object as measured from the neighbor cell.

4. The method of claim 1, further comprising the node requesting the user equipment unit to exclude the measurement result for the measurement object as measured from the neighbor cell from the additional measurement reporting of the measurement report.

5. The method of claim 1, further comprising the node requesting that the user equipment unit:
format the measurement report to comprise a measurement result report section (60) for the measurement object and an additional reporting section;
exclude the measurement result for the measurement object as measured from the neighbor cell from the additional measurement reporting section of the measurement report so that the measurement result for the measurement object as measured from the neighbor cell appears only once in the measurement report.

6. The method of claim 1, further comprising the node requesting the user equipment unit to include a reference signal received power (RSRP) value for the measurements of the additional measurement reporting.

7. The method of claim 6, further comprising performing a best cell evaluation for a carrier using one or more signal received power (RSRP) values included in the measurement report.

8. The method of claim 1, further comprising the node requesting the user equipment unit to include a reference signal received power (RSRP) value for an available measurement of a serving carrier from a non-serving cell.

9. The method of claim 1, further comprising performing a best cell evaluation for a carrier using the signal received power (RSRP) value.

10. A method of operating a user equipment unit which communicates with a communications network node comprising:
the user equipment unit sending a measurement report to the network concerning a measurement object for which the measurement report was triggered, the measurement report including (a) a measurement result for the measurement object as measured from a current serving cell and a measurement result for the measurement object as measured from a neighbor cell; (b) additional measurement reporting including measurements that are available at the user equipment unit from multiple serving carriers;
the user equipment unit, when performing the additional measurement reporting, including in the measurement report, the reference signal received power (RSRP) value for the measurement object as measured from the neighbor cell.

11. The method of claim 10, further comprising:
the user equipment unit, when performing the additional measurement reporting, including in the measurement report, as the measurement result for the measurement object as measured from the neighbor cell, both the reference signal received power (RSRP) value and the reference signal received quality (RSRQ) value.

12. The method of claim 10, further comprising the user equipment unit excluding the measurement result for the measurement object as measured from the neighbor cell from the additional measurement reporting of the measurement report.

13. The method of claim 10, further comprising:
the user equipment unit formatting the measurement report to comprise both a measurement result report section for the measurement object and an additional reporting section;
the user equipment unit excluding the measurement result for the measurement object as measured from the neighbor cell from the additional measurement reporting section of the measurement report so that the measurement result for the measurement object as measured from the neighbor cell appears only once in the measurement report.

14. The method of claim 10, wherein the measurement object is linked by a measurement identity to a measurement trigger, and wherein the method further comprises:
including in the measurement identity a list of serving frequencies which are linked to the measurement trigger; and,
other than a serving frequency corresponding to the measurement object, for each of the serving frequencies on the list including in the additional measurement reporting a measurement from a non-serving cell.

15. The method of claim 14, wherein the measurement for each of the serving frequencies from a non-serving cell is from a best non-serving cell, and wherein the measurement for each of the serving frequencies is a reference signal received power (RSRP) value.

16. A node of a communications network which communicates with a user equipment unit over an air interface, the node being arranged to configure the user equipment unit to send a measurement report to the network concerning a measurement object for which the measurement report is to be triggered, the measurement report including (a) a measurement result for the measurement object as measured from a current serving cell and a measurement result for the measurement object as measured from a neighbor cell; (b) additional measurement reporting including measurements that are available at the user equipment unit from multiple serving carriers;
the node being further arranged to request the user equipment unit to include a reference signal received power (RSRP) value for the measurement object as measured from a neighbor cell.

17. The node of claim 16, wherein the node is further arranged to request the user equipment unit to include both the reference signal received power (RSRP) value and a reference signal received quality (RSRQ) value for the measurement result for the measurement object as measured from the neighbor cell.

18. The node of claim 17, wherein the node is further arranged to request the user equipment unit to send a message which sets a parameter reportQuantity to require the user equipment unit to include both the reference signal received power (RSRP) value and the reference signal received quality (RSRQ) value for the measurement result for the measurement object as measured from the neighbor cell.

19. The node of claim 16, wherein the node is further arranged to request the user equipment unit to exclude the measurement result for the measurement object as measured from the neighbor cell from the additional measurement reporting of the measurement report.

20. The node of claim 16, wherein the node is further arranged to request the user equipment unit:
format the measurement report to comprise a measurement result report section for the measurement object and an additional reporting section;
exclude the measurement result for the measurement object as measured from the neighbor cell from the additional measurement reporting section of the measurement report so that the measurement result for the measurement object as measured from the neighbor cell appears only once in the measurement report.

21. The node of claim 16, wherein the node is further arranged to request the user equipment unit to include a reference signal received power (RSRP) value for the measurements of the additional measurement reporting.

22. The node of claim 21, wherein the node is further arranged to perform a best cell evaluation for a carrier using one or more signal received power (RSRP) values included in the measurement report.

23. The node of claim 16, wherein the node is further arranged to request the user equipment unit to include a reference signal received power (RSRP) value for an available measurement of a serving carrier from a non-serving cell.

24. The node of claim 16, wherein the node is further arranged to performing a best cell evaluation for a carrier using the signal received power (RSRP) value.

25. A user equipment unit which sends a measurement report over an air interface to a communications network node, the user equipment unit being arranged to prepare a measurement report (46) to send to the network concerning a measurement object for which the measurement report was triggered, the measurement report including (a) a measurement result for the measurement object as measured from a current serving cell and a measurement result for the measurement object as measured from a neighbor cell; (b) additional measurement reporting including measurements that are available at the user equipment unit from multiple serving carriers;
the user equipment unit being arranged, when performing the additional measurement reporting, to include in the measurement report, the reference signal received power (RSRP) value for the measurement object as measured from a neighbor cell.

26. The user equipment unit of claim 25, wherein the user equipment unit is further arranged, when performing the additional measurement reporting, to include in the measurement report, as the measurement result for the measurement object as measured from the neighbor cell, both the reference signal received power (RSRP) value and the reference signal received quality (RSRQ) value.

27. The user equipment unit of claim 25, wherein the user equipment unit is further arranged to exclude the measurement result for the measurement object as measured from the neighbor cell from the additional measurement reporting of the measurement report.

28. The user equipment unit of claim 25, wherein the user equipment unit is further arranged:
to format the measurement report to comprise both a measurement result report section for the measurement object and an additional reporting section;
to exclude the measurement result for the measurement object as measured from the neighbor cell from the additional measurement reporting section of the measurement report so that the measurement result for the measurement object as measured from the neighbor cell appears only once in the measurement report.

29. The user equipment unit of claim 25, wherein the measurement object is linked by a measurement identity to a measurement trigger, and wherein the user equipment unit is further arranged to:
include in the measurement identity a list of serving frequencies which are linked to the measurement trigger; and,
other than a serving frequency corresponding to the measurement object, for each of the serving frequencies on the list to include in the additional measurement reporting a measurement from a non-serving cell.

30. The user equipment unit of claim 29, wherein the measurement for each of the serving frequencies from a non-serving cell is from a best non-serving cell, and wherein the measurement for each of the serving frequencies is a reference signal received power (RSRP) value.
